(19) United States
(12) Patent Application Publication
(10) Pub. No.: US 2002/0091539 A1
(43) Pub. Date: Jul. 11, 2002

(54) Method and system for manging multiple interpretations for a single agreement in a multilateral environment

(75) Inventors: John Yin, Boca Raton, FL (US); Ramzi Yehia, Coral Springs, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: PartnerCommunity, Inc., Boca Raton, FL (US)

(21) Appl. No.: 09/840,655

(22) Filed: Apr. 23, 2001

Related U.S. Application Data
(63) Continuation-in-part of application No. 09/757,227, filed on Jan. 9, 2001.

(51) Int. Cl. G06F 17/60

(52) U.S. Cl. 705/1

(57) ABSTRACT

A method and system for monitoring contracts in a multilateral environment. The multilateral environment includes two or more trading partners trading goods and services. The system is based on hub and spoke architecture. The hub presents to each of the partners using a partner system a user interface for receiving one or more contract clauses, and defining and extracting its own version of metadata based on and from the contract clauses. A graphical user interface presented on the partner system permits one or more customizable rules to be defined, wherein each rule includes at least one condition and one or more actions to perform in response to the condition. The system monitors the one or more contract clauses with the rules. The system performs one or more predefined actions when a contract clause satisfies the requirement of the customizable rules.

### CROSS REFERENCE TO RELATED APPLICATIONS

This is a continuation-in-part of a non-provisional patent application Ser. No. 09/757,227 filed Jan. 9, 2001 now [Pending], for “Method And System For Managing And Correlating Orders In A Multilateral Environment”, which is commonly assigned herewith to PartnerCommunity, Inc. and hereinto in its entirety by reference.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### BACKGROUND OF THE INVENTION

1. Field of the Invention

This invention generally relates to the field of management system for contracts and more particularly to the customized interpretations of contract terms and conditions in a multilateral environment.

2. Description of the Related Art

The Internet and World-Wide-Web has created unprecedented growth in communications. On the Internet, B2B (business-to-business), also known as e-biz, is the exchange of products, services, or information between businesses rather than between businesses and consumers. Although early interest centered on the growth of retailing on the Internet (sometimes called e-tailing), forecasts are that B2B revenue will far exceed business-to-consumers (B2C) revenue in the near future. According to studies published in early 2000, the money volume of B2B exceeds that of e-tailing by 10 to 1. Over the next five years, B2B is expected to have a compound annual growth of 41%. The Gartner Group estimates B2B revenue worldwide to be $7.29 trillion dollars by 2004. In early 2000, the volume of investment in B2B by venture capitalists was reported to be accelerating sharply although profitable B2B sites were not yet easy to find. B2B Web sites can be sorted into several categories:

Company Web sites, where the target audience for many company Web sites is other companies and their employees. Company sites can be thought of as round-the-clock mini-trade exhibits. Sometimes a company Web site serves as the entrance to an exclusive extranet available only to customers or registered site users. Some company Web sites sell directly from the site, effectively e-tailing to other businesses.

Specialized or vertical industry portals, which provide a “subWeb” of information, product listings, discussion groups, and other features. These vertical portal sites have a broader purpose than the procurement sites (although they may also support buying and selling).

Information sites (sometimes known as infomediary), which provide information about a particular industry for its companies and their employees. These include specialized search sites and trade and industry standards organization sites.

Brokering sites that act as an intermediary between someone wanting a product or service and potential providers. Equipment leasing is an example.

Product supply and procurement exchanges, where a company's purchasing agent can shop for supplies from vendors, request proposals, and, in some cases, bid to make a purchase at a desired price. Sometimes referred to as e-procurement sites, some serve a range of industries and others focus on a niche market.

Many B2B sites may seem to fall into more than one of the categories above. Models for B2B sites are still evolving. (For more information on B2B refer to online URL www.whatis.com).

As participants in the B2B sites, providers of goods and services in the e-procurement and brokering sites strive to differentiate themselves from one another. These providers strive to build the best-of-breed set of services. One method these providers provide services is through the aggregation of services from one or more other providers. Providers understand that the basic venue for providing superior services lies in partnership. Many times these providers establish multilateral, complex partnering relations. Multilateral activities include many providers cooperating to provide a service or product to a customer. However, partnering arrangements are leading to new and unforeseen circumstances where service providers have a multitude of contracts with different partners.

One example of a multilateral relationship is as follows. The provider A is negotiating a contract with provider B to supply a service that A has purchased from provider C. Stated differently, A is reselling a service purchased from C to B. As a case in point, A may be reselling Internet bandwidth that has purchased from C. Often times, it is a requirement for provider A to be alerted during the negotiation that fulfillment of the new contract requires either, renegotiate the contract with partner C or decrease the commitment to partner B. This notification requirement could be due to the capacity that A is purchasing from C or due to other contracts that A committed to with other partners. On another hand, the notification requirement may be advantageous to partner C to design a contract with partner A based on the contracts of A with B. The managing of contract and notifications can be problematic, especially in multilateral relationships. Accordingly, a need exist for a method and system to manage the notifications for orders and contracts in a multilateral environment.

These multilateral relationships require coordination of contracts that are interdependent, complementary, and chained nature leading, to complex and intractable situation. In this environment contracts with other providers act as virtual inventory so, it is very critical to track orders against contracts and be able to initiate multilateral actions based on events relevant to contract terms. Accordingly, a need exists for an integrated order management, contract management and inventory system that has the visibility to the multilateral relations between partners.

One available system for contract management is ConTrack™ from Indigo Solutions™ and for order management is TBS from Metaslov. When a party to a multilateral contract detects a violation in a contract, the party typically turns one of these systems to review contract information. These currently available contract and order management systems although useful are not without their shortcomings. One shortcoming is that the currently available systems are stand-alone. The term stand-alone as used here means that these systems are installed at a given party's location without connection to the other party. The lack of connectivity prevents these stand-alone systems from initiating, coordinating and synchronizing actions/alerts in the multilateral environment. At the best, current contract management systems alert a user about critical dates of a contract but cannot associate and initiate actions that affect all parties related under the contract.

Another shortcoming with the current stand-alone order management systems are the inability to track contracts versus the orders, the status, the backorders, the fulfillment and many times the inventory. Accordingly, a need exists to provide a method and system to over come the shortcomings of these stand-alone contract and order management systems and to provide a system that can work with multiple contracting partners and parties.

Still, another shortcoming with existing stand-alone contract and order management systems is illustrated by an example in the telecommunication industry of prepaid service such as prepaid calling cards or prepaid cellular time. These prepaid systems can be thought of as a contract for the delivery of telephone service for a given price under certain terms and conditions. Typically the customers of these prepaid systems want to monitor the usage of their prepaid plan. Some of today's telecommunications systems notify the customer when the amount of usage approaches the prepaid amount and will cut off the service when the prepaid amount is completely used. However, these currently available contract and order management systems are tailored towards customer-to-business relations and they serve very specific functions. They also, do not provide a mechanism to notify other parties or partners of usage. For example, in the prepaid case, the service provider is not alerted to the fact that the customer used all of his prepaid credit. By not knowing the expiration of the prepaid credit, the service provider lost the chance to solicit further business from the customer. Accordingly, a need exists for a method and system to over come the shortcomings described here as well.

Still, another concern in multilateral contract management is the requirement to negotiate each of the contract terms with each of the parties in a multilateral environment. It is not uncommon for provider's contracts to be ten, twenty or even fifty pages in length. The requirement for each partner in the supply chain to negotiate with another partner in the supply chain is tedious and often requires significant legal expense. In addition, today's contract processes are manual and therefore expensive. The slow and tedious process of contract negotiations typically increases as the number of parties in the supply chain increases. Providers in the supply chain require quick time to market including the ability to replace existing services, and add new ones, on demand and in cases of service failures. Current contract systems do not offer solution for the multilateral environment of today's B2B transactions. Accordingly, a need exists for a system and method to overcome the above concerns and shortcomings and to provide automatic negotiation of contracts in a multilateral environment.

Still another problem with current methods of contract negotiation that are manual is the susceptibility to human error. Today most contract negotiations depend on the negotiating individuals and their ability to capture and remember all existing contracts. This process is error prone, especially when considering the dynamics of current organizations and the potential of negotiating contracts by different individuals at different times and belonging to different departments and with different intentions. Currently available systems that provide contract management concentrate on managing individual contracts. That is, the current available systems monitor critical dates of those contracts, they categorize contracts and the group of contracts into active and non active ones. Although these features are useful, the currently available systems have an inherent problem when deployed in a multilateral environment. The currently available systems do not track dependencies between contracts of different partners and do not provide visibility to the chained nature of contracts. For example, it is common for contracts to have a performance clause that guarantees performance of the contracting parties. The tracking to avoid conflicts between performance clauses in multilateral relationships is problematic. Accordingly, a need exists for a system and method to overcome the above concerns and shortcomings and to provide automatic negotiation of contracts in a mutlilateral environment.

Yet, still another problem with current methods of contract management systems is in the area of contract monitoring. Some examples are setting up reminders for necessary follow up, making sure payments, commissions and other terms and conditions are performed when they are required. Current methods for contract monitoring are both manual and human intensive. One known solution is to install standalone applications on each partner's system and setup their own customized monitoring. This solution although useful, requires all parties to a contract to install contract management software on their systems. It also, requires duplication of work to enter data into the multiple systems. The maintenance across multiple systems is a major disadvantage to this distributed approach. Specifically, adding an addendum or modifying a contract many times leads to situations where copies of the contract (on different systems of the parties) are not synchronized. Other prior art systems provide multiple contracting parties the visibility to a single contract. However, these prior art systems do not provide customized monitoring. These prior art systems rely on the originator of the contract to be the owner. So, only one set of data elements are saved and those are considered the owners monitoring elements. Accordingly, a need exists for a method and a system to over come the above shortcoming of the prior art contract management systems and to provide a centralized contract system with customized interpretations.

### SUMMARY OF THE INVENTION

Briefly, according to the present invention, a method and system is disclosed for managing multiple interpretations for a single contract in a multilateral environment. The multilateral environment includes two or more trading partners trading goods and services.

The present invention provides a method and system that: (1) associates multiple sets of metadata elements, critical items, with contract terms and conditions. Each set of critical items is owned by one of the parties to a contract and constitutes its interpretation of the contract. In this respect the set of critical items is not limited to items explicitly included in the contract document, (2) associates a set of rules with each set of critical items. Rules are made up of conditions, applied to the critical items, and actions to be taken, (3) track the critical items, validate the conditions, and perform the rule actions.

Associating multiple sets of critical items with a contract allows each party to a contract to have it's own interpretation of the contract. It is natural for each party to a contract to monitor elements that are important to them irrespective of its importance to the other parties. Different parties may also have their own conditions and requirements for monitoring data elements. For example, let's assume that service provider A is contracting to host equipment for service provider B in a co-location mode. Service provider A provides a fixed rack space, network connectivity and power to provider B. Service provider B provides the insurance for the equipment. In this case service provider A may be interested in monitoring the insurance renewal date to make sure that provider B is renewing the insurance properly. Whereas, service provider B may be more interested in tracking the number of power outages to the rack.

Even, when parties to a contract track the same data elements more often then not they associate different conditions and actions (rules) with those data elements. In the example in the previous paragraph provider B, for a different reason, may also be interested in tracking the insurance renewal date. Whereas, Provider A is interested in the knowledge that the insurance policy is renewed provider B, is interested in a reminder to start the process of renewing the policy. It is clear that provider B needs an earlier notification than provider A. So, provider B may require a reminder one month prior to the renewal date whereas, provider A requires a reminder on the renewal due date.

The system is based on a hub and spoke architecture. Partners add contracts, contract metadata and rules into the system. In one scenario, the contract metadata is retrieved from the contract itself. That is, the contract is parsed and a set of tagged data elements is retrieved. Each tag represents a predefined field in a contract such as price, quantity, delivery date and other contractual terms. The data elements are placed into a database schema using a naming structure that is identical to the naming structure used for the tag values so that elements in the database schema can be populated directly from the tag values. In another scenario, the hub provides a user interface for entering the contract, contract metadata and rules. Once in the system, contract metadata is analyzed against the entered rules. If required, immediate actions are taken otherwise, schedules are prepared and a running dispatcher will execute the actions on the due date and time .

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a high-level system view of the hub and spoke architecture according to the present invention.

FIG. 2 is a block diagram illustrating the overall data flow for tag values between partners, according to the present invention.

FIG. 3 is a functional block diagram of the major system components using the hub and spoke architecture of FIG. 1, according to the present invention.

FIG. 4 is flow diagram of the order reconciliation according to the present invention.

FIGS. 5A and 5B are a schema of an order entity relationship detailing the relationship between entities, according to the present invention.

FIGS. 6A and 6B are a template of the XML order tags used along with the order entity schema of FIG. 5, according to the present invention.

FIG. 7 is a tree diagram of the XML order tags in FIG. 6, according to the present invention.

FIG. 8 is flow diagram of the contract reconciliation according to the present invention.

FIG. 9 is a schema of a contract entity relationship schema detailing the relationship between contract components, according to the present invention.

FIGS. 10A and 10B are a template of the XML contract tags used along with the contract entity schema of FIG. 9, according to the present invention.

FIG. 11 is a tree diagram of the XML contract tags in FIG. 10, according to the present invention.

FIG. 12 is flow diagram of managing multiple interpretations for a single contract, according to the present invention.

FIGS. 13A and 13B are a database schema to support the contract and contract metadata, according to the present invention.

FIGS. 14A, 14B, 14C and 14D are a template of the XML contract tags used along with the contract entity schema of FIGS. 13A and 13B, according to the present invention.

FIGS. 15A, 15B, and 15C are tree diagrams of the XML contract tags in FIG. 14A-C, according to the present invention.

FIG. 16 is a database schema to support associating rules with contracts as shown in FIG. 13, according to the present invention.

FIGS. 17A, 17B, and 17C are a template of XML rule tags used along with the rules and contracts schema of FIG. 16, according to the present invention.

FIGS. 18-23B are a series of screen shots illustrating the customized interpretations of a contract, according to the present invention.

FIG. 24 is an exemplary screen shot for STEP 5, which is entered only after a contract critical item(s) has been previously defined, according to the present invention.

FIG. 25A-25I are a series of screen shots illustrating creating rules based on the customized views, according to the present invention.

### DETAILED DESCRIPTION OF AN EMBODIMENT

It is important to note, that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

Glossary of Terms Used in This Disclosure

Contract Interpretation—a user determined set of data associated with terms and conditions from a contract between one or more parties.

Critical Item(s)—one or more key data elements of a contract's terms or conditions which a given user wishes to track and monitor. The critical items are those key data in a contract that subsequent rules monitor to perform a predefined action.

Good—is any fungible or non-fungible item that is exchanged between partners with or without the exchange of any valuable consideration such as money or credit.

Hierarchical relationship or hierarchical contractual relationship—is a contractual relationship between two or more partners in a value chain. The contractual relationship is manifested by one or more contracts established between the partners. The target of the relationship is to provide a set of goods or services to one or more customers. The contracts are linked together through one or more common identifiers. The common identifiers include partner identities, good or service identifiers, identifiers of related or dependent goods or services, or other item common in a given value chain. Two examples of hierarchical relationships include:

Order—a hierarchical contractual relationship that covers the same identifiers as specified by an order.

Contract—a hierarchical contractual relationship that covers the same identifiers as specified in a contract.

Hub—In describing network topologies, a hub topology consists of a backbone (main circuit) to which a number of outgoing lines can be attached (“dropped”), each providing one or more connection port for device to attach to. The hub is the central information processing system(s) that communicates with one or more partners over a network.

Information Processing System—is any computer or similar device such as a personal computer, mid-size computer, main-frame computer, PDA, cellular phone or any device capable of communicating with a network.

Member—a partner that has joined a specific community such as PartnerCommunity, Inc. (see online URL www.partnercommunity.com for more information).

Multilateral—an environment where one or more partner or member participates in the Value Chain.

Network—a wired, wireless or broadcast connection between two or more partners that includes the Internet, Intranets, WANs, POTS, cellular, satellite and other communication networks.

Partner—is an entity in a value chain of goods and services that is either a provider or consumer. A partner may be an individual, company or another entity such as a government that contracts for goods and services.

Rules—one or more conditions to apply to a given set of facts to determine a procedure to be followed. The rules are used in an inference based engine with IF THEN constructs. A set of rules usually work on a top-down principle in which the first rule in the list is acted upon first, so that conditions allowed by the first rule, will never be judged by the remainder of the rules. Rule bases typically have the format of SOURCE/DESTINATION/SERVICE/ACTION.

Service—any item including a good, service, money or the movement thereof, that a Subscriber may use. One class of Service is communication services, such as POTs (Plain Old Telephone Service) line, cable line, cellular line, satellite, T1 or TCP/IP connection or equivalent. Another class of Service is utilities such as gas, oil, electric, water, sewer purchased by a Subscriber. Still, another class of Service is transportation such as ticketing, tolls, freight charges, and shipping charges.

Service Level Agreement (SLA)—is a type of contract between a network service provider and a customer that specifies, usually in measurable terms, what services the network service provider will furnish. Many Internet service providers (Internet service provider) provide their customers with an SLA. More recently, IS departments in major enterprises have adopted the idea of writing a Service Level Agreement so that services for their customers (users in other departments within the enterprise) can be measured, justified, and perhaps compared with those of outsourcing network providers. Some metric that SLAs may specify include:

What percentage of the time services will be available;

The number of users that can be served simultaneously;

Specific performance benchmark to which actual performance will be periodically compared;

The schedule for notification in advance of network changes that may affect users;

Help desk response time for various classes of problems;

Dial-in access availability; and

Usage statistics that will be provided;

Value Chain—is an alliance of product and service providers coming together to provide a complete offering to a given set of customers.

Overview of Managing and Correlating Orders and Contracts

In this embodiment, the present invention provides an integrated system to automatically and continuously manage orders and contracts among trading partners The system tracks orders against contracts then, notifies and or reminds the trading partners of critical events and activities, including important dates, compliance and violations of the contractual terms. The present invention also allows trading partners, in a mutlilateral value chain, to define and add their rules for automatically generating notification, reminders, and triggering actions depending on the events. For example, a contract between two service providers may include a provision that one party commits to purchase 20,000 email boxes from the other party in the year 2000. In this case, an order would be an actual purchase of, for example, 25 email boxes. An example rule is to notify the providing partner if the quantity of orders does not increase linearly with time at a rate that allows ordering the 20,000 email boxes over one year.

The system uses a hub and spoke architecture where all contract information between trading partners is stored at the hub and all orders between the trading partners go through the same hub. The system consists of: (1) a user interface that allows one trading partner to enter orders to be sent to other trading partners, (2) a programmatic interface that allows one trading partner to enter orders to be sent to other trading partners; (3) a user interface that allows trading partners to enter coordination rules; that is, conditions as related to orders and contracts and respective actions to be taken; (4) an analysis engine that tracks the orders and performs the analysis according to the provided rules; and (5) an action processor that performs actions as determined by the analysis engine.

Overview of Contract Management System

In this embodiment, the present invention provides a system and an architecture to: (1) automatically reconcile and coordinate related contracts in a value chain to ensure consistency among the contracts between the trading partners in the value chain, (2) automatically generate warnings and take actions for any inconsistencies, (3) streamline the contract generation process, and (4) enable service providers to automatically and programmatically negotiate service contracts.

Hub and Spoke Architecture

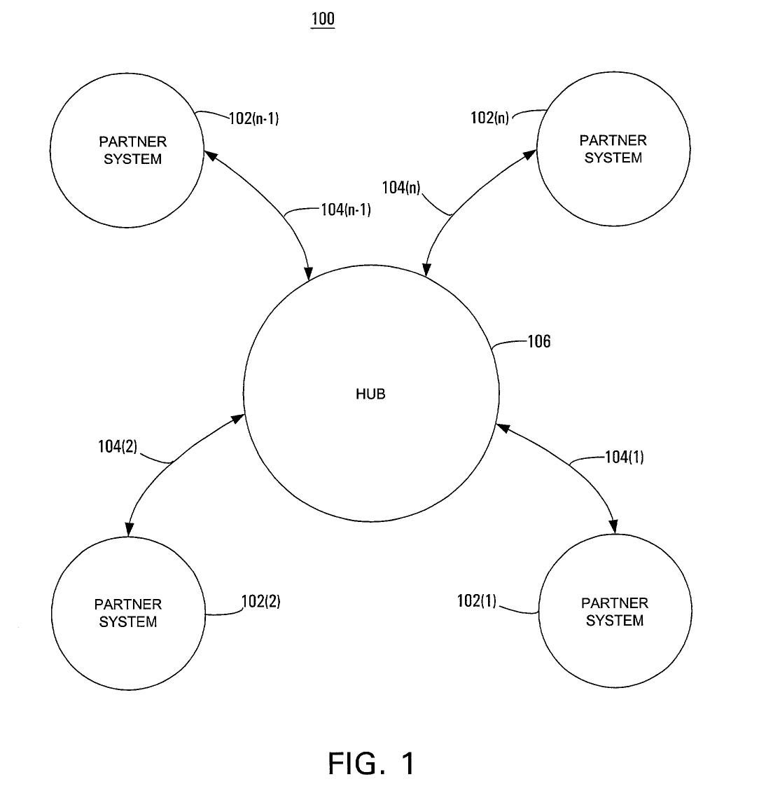

FIG. 1 is a high-level system 100 view of the hub and spoke architecture according to the present invention. The analogy of hub and spoke architecture comes from a wheel with a hub connecting to many spokes. In data communications, a hub is a place of convergence where data arrives from one or more directions and is forwarded out in one or more other directions. Here a hub 106 is the central information processing system that is connected over a network connection 104 (i.e., the spokes) to a partner system 102. Note there is a plurality of partner systems 102 (1, 2 . . . n−1, n) shown each connected via a network connection 104 (1, 2, . . . n−1, n) to the single hub 106.

Using the hub and spoke architecture 100 enables connectivity and therefore visibility to multi-dimensional and chained contracts the system 102 of each partner. In this architecture 100, partner systems 102 are connected to a central hub 106 where the contract management is provided as further described below. Connection to the hub 106 can use a multitude of communication protocols and could be achieved through different set of user interfaces. As describe in the section below, the hub 106 and partner system 102 can be produced in a variety of hardware and software combinations.

Discussion of Hardware and Software Implementation Options

The present invention, as would be known to one of ordinary skill in the art could be produced in hardware or software, or in a combination of hardware and software.

The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

Overall Data Flow for Tag Values Between Partners

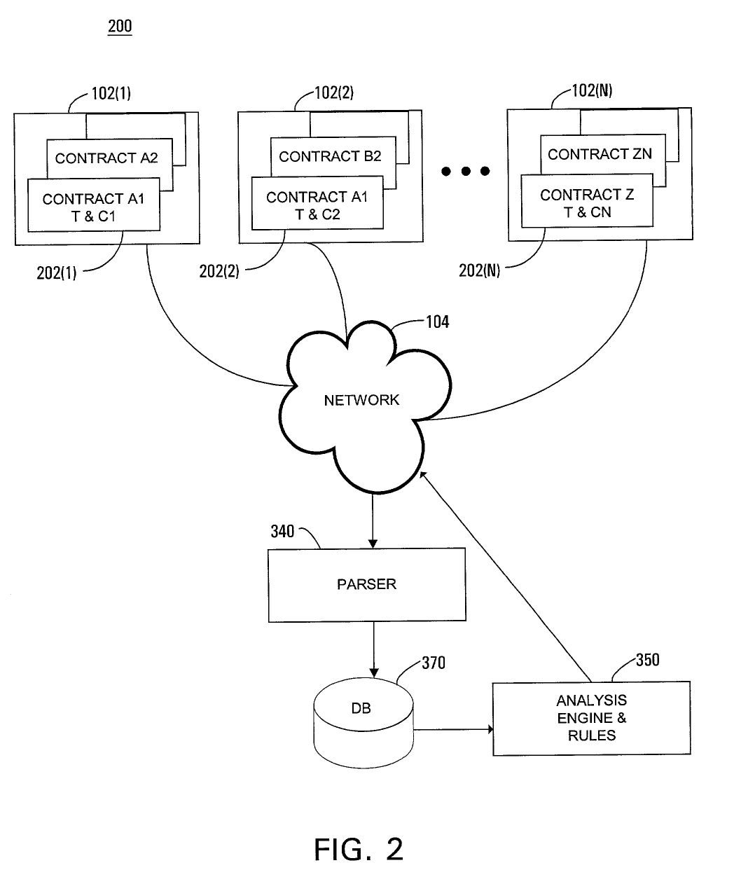

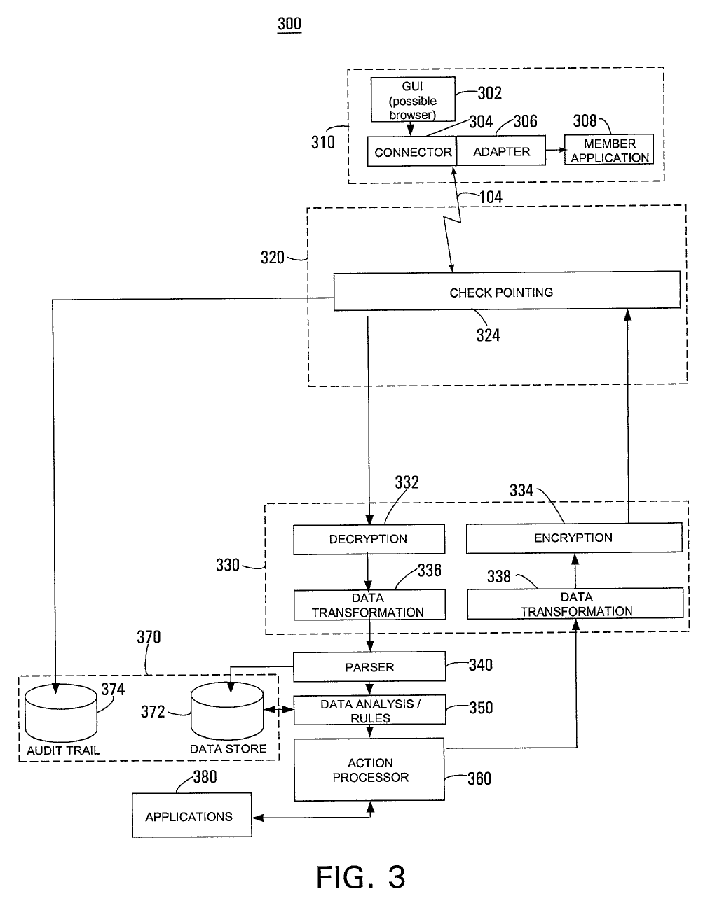

FIG. 2 is a block diagram 200 illustrating the overall data flow for tag values between partners using the hub and spoke architecture 300 of FIG. 3, according to the present invention. Each of the partner systems 102 (1, 2, . . . n−1, n) populates one or more documents 202 (1, 2, . . . n). Here the documents are contract templates built using DTD (data type definitions), XML schemas and/or XML documents. Each of these documents 202 (1, 2, . . . n) are sent over the network 104. A DTD parser, such as an XML parser retrieves the elements from each of the documents 202 and puts them into a database according to the XML tag values. The stored tag values are retrieved by the data and rules analysis engine 350 based on as predefined relationship such as by a partner identifier such as accountID. In order management embodiment, the orders belonging to the same accountID (e.g. partner) are retrieved. In the embodiment of contract negotiations all the contracts belonging to the same account are retrieved. Once the relevant stored tag values are retrieved from the database 370 depending on the embodiment, the data and rules analysis engine 350 are applied. And depending on the action from action processor 360 one or more of the partner systems 102 (1, 2, . . . n−1, n) are notified as required.

The partner systems 102 also enable through a interface 302 other input besides the contracts or orders such as individualized rules for the data and rules analysis engine 350 and actions to be performed by action processor 360.

Functional Block Diagram of Hub and Spoke Architechture

FIG. 3 is a functional block diagram 300 of the major system components using the hub and spoke architecture of FIG. 1, according to the present invention. The system 300 includes two basic components; a client component and hub (or server) component. Each of the two components is further divided into other subcomponents. The client component or client connector 310 is an application that resides on each of the partner's systems 102 and the second component is an application running on the hub 106 that connects all the partners systems 102. The client connector 310 residing on the partner's site includes a user interface 302 and/or a programmatic interface that allows partners to enter their orders. In one embodiment, the user interface 302 is a web browser. In another embodiment the interface 302 is a traditional order entry product where partners keep their individual view of the orders. The client connector 310 includes a connector 304 and adopter 306. The connector performs the task of communication, encryption and/or data transformation, sending orders and receiving acknowledgement, to the hub 106. The adopter 306 provides communication with member application 310. This allows members to continue operations, as before, using their back office applications for tracking their internal processes however, now with the additional benefit of multilateral functions provided by the Hub.

In another embodiment, the user interface 302 allows partners to enter their own rules for handling discrepancies between their orders and contracts as is further described in the section contract management below.

The hub 106 consists of six major components: channel 320; data transformation 330; parser 340; the data and rules analyzer 350; action processor 360 and databases 370. The overall process flow at the hub 106 is as follows:

Client Connector 310—The client connector 310 communicates with the Channel 320. The client connector provides user using partner systems 102 with a set of contract templates. Users fill-in these templates and insert controls, using interface 302, that is used during the other partner's modifications. This component is installed on each partner systems 102 (1, 2, . . . , n−1, n) and communicates the contracts to the hub 106 over network connection 104 (1, . . . , n−1, n). Communication with the hub 106 can be a web-based or programmatic message-based communication. For the web-based communication the connector 310 uses web browser infrastructure technologies such as Netscape Communicator™ or Microsoft Explorer™. In one embodiment, browser-based products like Pureedge™ are used to provide forms and support for digital signatures for the full or part of the form. For the message-based communication the channel 320 uses B2B integration servers like Microsoft BizTalk™ Server, Extricity Alliance™ server or other messaging products. In another embodiment, the user interface running on the partner systems 102 is a GUI that is specifically developed for this purpose, or through a programmatic connection to existing contract management systems. Example contract management systems that serve this purpose is ConTrack™ from Indigo Solutions™.

Channel 320—provides the protocol translation between the two negotiating partner systems 102 (1, 2, . . . , n−1, n). It will also serve as a checkpoint for audit trail purposes. In order to provide this functionality different technologies can be used to support web-based and message-based communication. Examples of web-based communication web and application server's technologies that support the communication include Microsoft® IIS, Apache web server and/or BEA Weblogic™ server. Examples of programmatic message-based technologies are products like BizTalk™ Orchestration or Extricity Alliance™. The channel 320 provides a checkpoint 324 via an audit trail stored in audit database 374.

Data Transformation 330—this component provides the data transformation 336, 338 between the two partner systems 102 (1, 2, . . . , n−1, n). As mentioned for the channel 320 products like BizTalk Orchestration or Extricity Alliance™ server can support both protocol translation and data transformation and has been found to produce desirable results. Before performing the data transformation it may be necessary to decrypt the message. Encryption 334 and decryption 332 use standard technologies. Different algorithms exist for encryption technologies. In one embodiment, the use of Public Key Infrastructure (PKI) provides acceptable results.

Parser 340—extracts the data elements from the received documents and stores those elements in the database 372. XML is used as an efficient method for building contract templates. Recently the World Wide Web Consortium (W3C) adopted the Extensible Markup Language (XML) as a universal format for structured documents and data on the Web. The base specifications are XML 1.0, W3C Recommendation February ′98. (See online URL www.w3.org for more information. The system 300 by being based on XML along with (Extensible Stylesheet Language) XSL enforces separation of content and presentation, thus allowing flexible rendering of the content to multiple device types. Similarly, the use of XML enables maximal reuse of information and data through the composition of XML fragments. One parsing tool which produces desirable results is Xerces (refer to online URL xml.apache.org for more information.) The parser 340 is used to extract data elements from contracts or other forms and store them in databases like Oracle™ or MS SQL server™. The results of the data transformation function are passed to the parser 340, which extracts the data elements and stores those elements in the database 372.

Data and Rules Analysis Engine 350—correlates the orders and contracts between partners. The correlation uses a relational database 372 that links orders with accounts and contracts. The data and rules analysis engine 350 determines all other contracts that are owned or related to the contract under negotiation based on the entity relationship; and based on captured rules and associations between those contracts a set of processing actions are taken. In one embodiment this component is rule or constrained based inference engines. Exemplary products that produce desirable results are ILOG rules from ILOG™ or Blaze Advisor™ from Blaze software.

Action Processor 360—processing actions that are required to support the decisions made by the analysis engine. Example actions are sending email, sending messages to connectors, forwarding contract to addressed party and much more. Proprietary software components are developed to receive the action type, determine the respective application 380 to carry out the action then, call this application. Based on the required action the application could be as simple as an e-mail server or as sophisticated as messaging software.

Orders and Correlating Contracts at the Hub

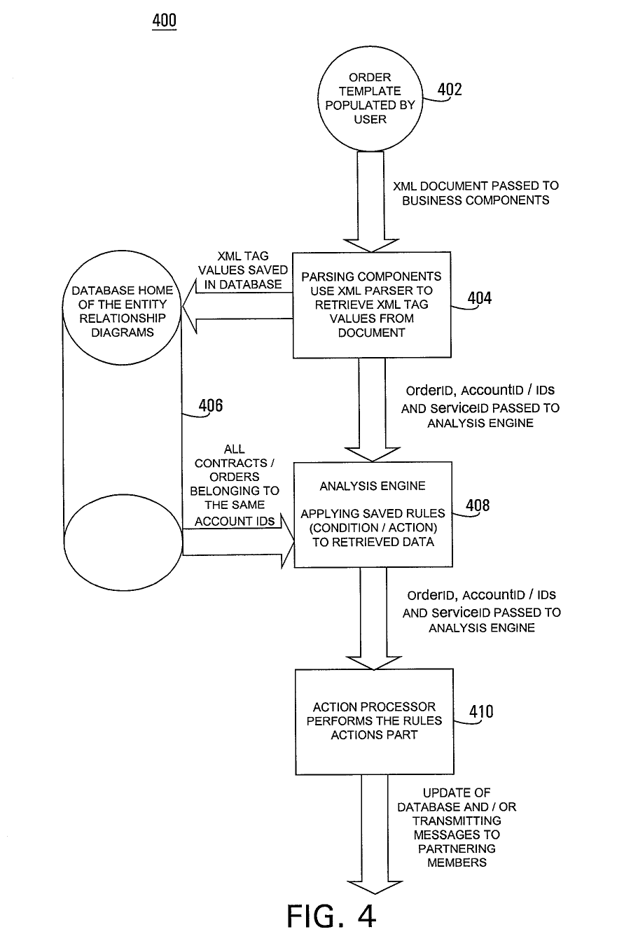

FIG. 4 is flow diagram 400 of the order reconciliation according to the present invention. Using the user interface 302 on partner system 202, the order template based on XML is populated by the user, step 402. The order template is passed over network 104 to hub 106 for processing. The parser 340 extracts the order data from the order template, step 404. The order data includes order attributes, order action class (e.g. activation, open order), identification numbers of ordering party, order line items (services covered in the contract), and other attributes.

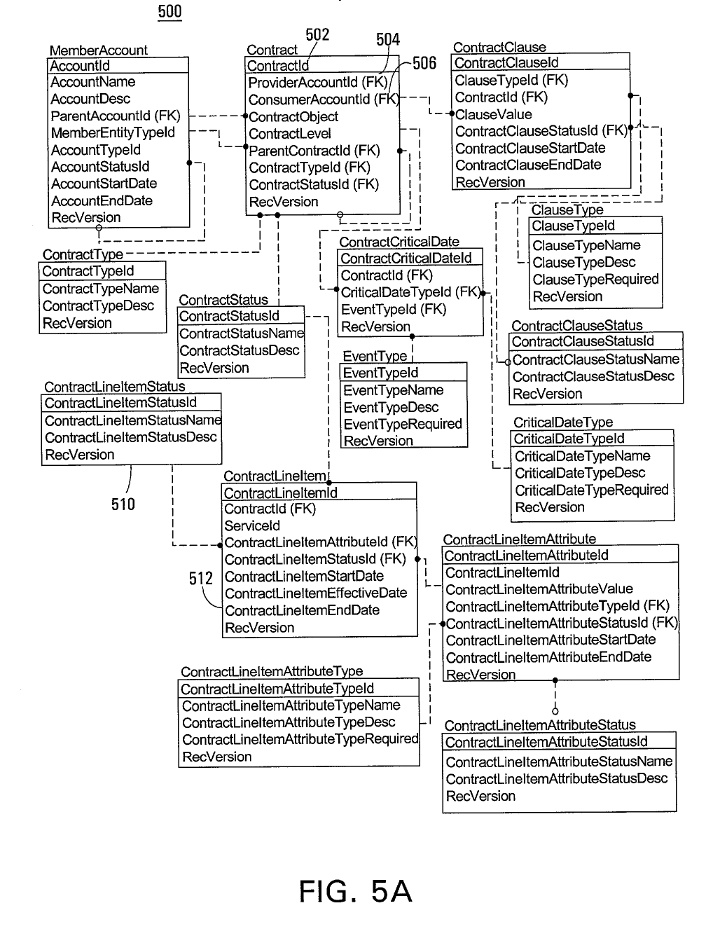

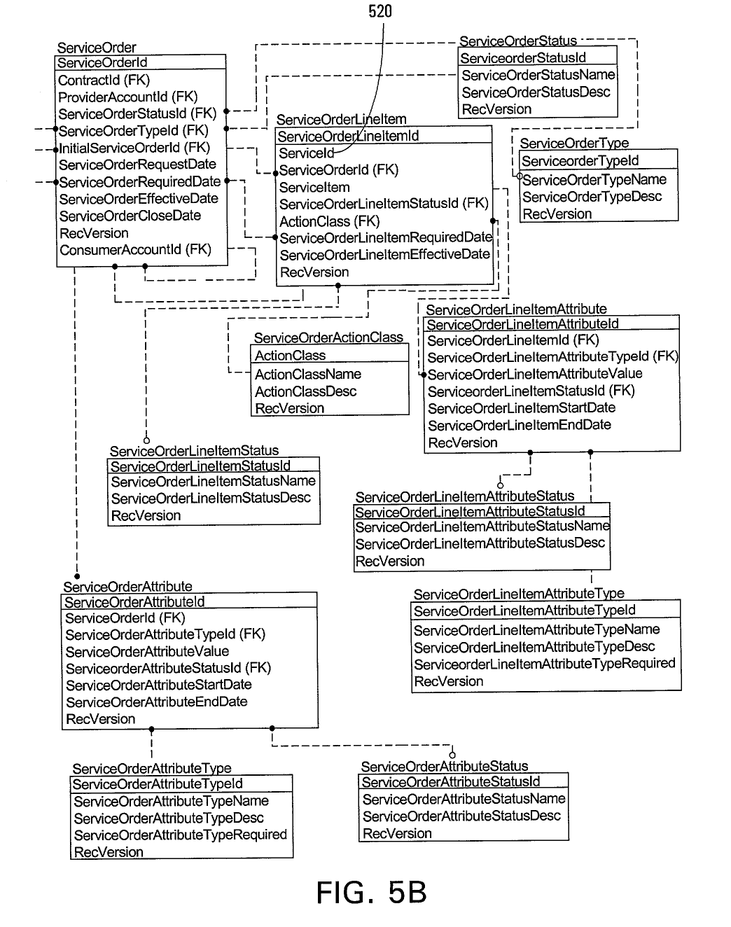

Using SQL the parser 340 saves the information retrieved from the XML order template into the database 370, step 406. The schema of the database is shown in FIG. 5 and discussed in further detail below.

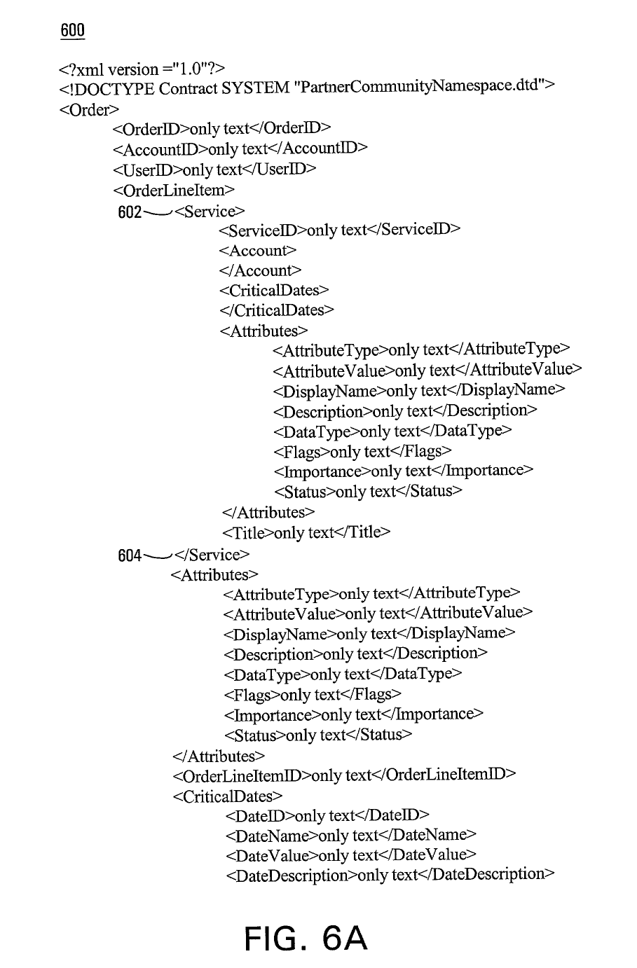

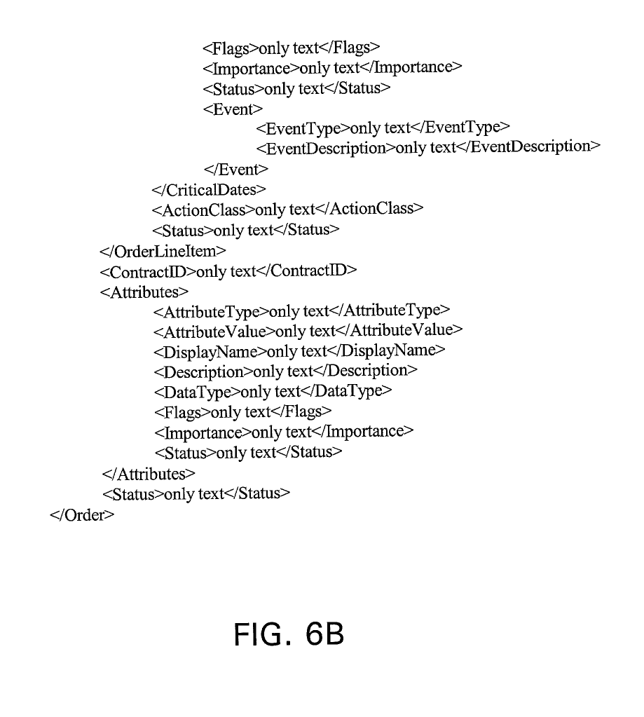

An identical naming convention is used in the XML document structure and the database 370 entity relationship diagram as shown in FIG. 6. Those of average skill in the art understand the map the data (tag values) from the XML document into table rows in the database. For example, the values of the XML tags AccountId and OrderLineItem under the tag Order in the XML document contain the values, mapped into the columns ProviderAccountId 530 in the service order table and OrderLineItemId 532 in the ServiceOrderLineItem table in the database. The same principle applies to the values of the other tags in the XML document.

In step 408, the parser components pass the OrderId 534, ProviderAccountId 530 and serviceIds 536 to the data and rules analysis 340. The tag naming in the XML document clearly identifies those Ids. Using the OrderId 534 the data and rules analysis engine 340 retrieves all the Orders and contracts related to the same service Id and belonging to the parties with the same account Id. It should be understood that the data and rules analysis engine 340 could also retrieve all Orders and contracts by other parties in that already established contracts with 530. The data and rules analysis engine 340 applies rules that were previously configured by the contracting parties and passes the required actions to the action processor 350.

In step 410 the action processor performs the actions based on the request of the data and rule analysis engine 340. The action processor may use other applications for the completion of the required actions. An example application is an e-mail server like Microsoft Exchange. So, the action processor forms the messages and passes it to the email server to send.

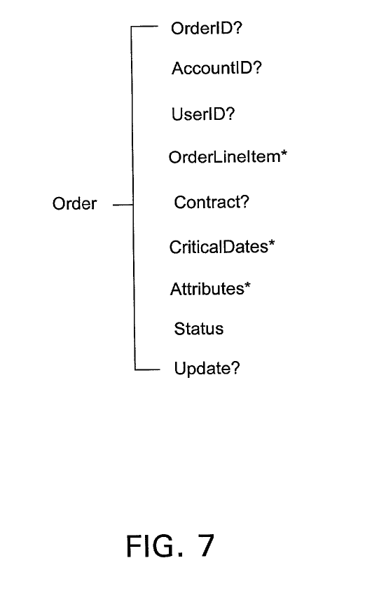

FIG. 5 is a schema 500 of an order entity relationship detailing the relationship between entities, according to the present invention. The schema 500 is saved in a relational database 372 such as Oracle™, Informix™, DB/2™, or SQL server™. The schema uses the notation of a dark circle one or both ends of a connecting line to denote a “one to many” relationship with the object connected by the black dot. For example the component “contractlinestatus” 510 has a “one to many relationship” with the component “contractlineitem 512. The schema details the relationships between members and objects. The schema shows the relation between orders, services being order and account information for the partner issuing the order. This same relation is also carried through the XML fragments as shown in FIG. 6 and FIG. 7. So, the parser can easily extract the data from the XML fragments and insert it into the database 372.

Returning to an example given above in the overview section of the e-mail boxes, assumes that a contract between two service providers, A and B, include a provision that one party commits to purchase 20,000 email boxes from the other party in the year 2000. In this case, an order, from provider A, would be an actual purchase of, for example, 25 email boxes.

The parser 340 extracts from the order the service identification, the quantity ordered, the action type of the order (example actions are reservation, activation), and the parties account numbers. Now, component data and rules analyzer engine 350 using data provided by parser 340 retrieves from the data store information in database 372 about all other orders for this service and the contracts having this service as a line item. Rules, saved in the rules analyzer, are applied to this data to help guide the business between the partnering providers. Providers use the interface 302 to enter rules into the system. Rules are saved as rule language files that are specific to the rule or constrained based inference engine being used. An example processing is:

If the sum of service order, from A, exceeds the contract quantity reject the order.

Another rule is:

If the sum of the service orders, from A, is within a certain percentage of the contract quantity process the order and send a notification back to ordering party.

Another rule is:

If the sum of the service orders is within a certain percentage of the contract quantity

AND

If the date of the order is within a certain window from the contract renewal date,

THEN

Process the order and initiate a contract negotiation process.

A more sophisticated and takes into consideration the contracts between provider B and his suppliers of services that support the ordered service. Such a potential rule is:

If the sum of service orders, from A, are within a certain percentage of the contract quantity

THEN

Send an order to provider C based on a separate contract between B and C.

Other rules include implications of the quantities ordered and the time period on pricing and potential discounts.

Turning now to FIGS. 6A and 6B are a template XML of the order tags used along with the order entity schema of FIG. 5, according to the present invention. The XML order 600 follows the rules of XML where each item starts with an opening tag 602 and a closing tag 604 where the convention is the closing tag 604 has the identical name preceding by a “/” in this example the opening tag 602 is “service” and the closing tag 604 is “/service”.

FIG. 7 is a tree diagram 700 of the XML order tags in FIG. 6 according to the present invention. The elements in the tree diagram are defined as follows:

OrderID 602—OrderID is the numerical unique identifier for the Order object instance.

AccountID 604—AccountID is account ID of the account that has the user making the order for the Order object instance.

UserID 606—UserID is the user that is making the order for the Order object instance.

Status 608—Status is one of a list of possible states associated with the Order object instance (New, Deleted, Changed, Invalid, Owner, . . . ).

OrderLineItem 610—OrderLineItem is the embedded OrderLineItem logical object associated with the Order object instance.

Contract 612—Contract is the embedded Contract logical object associated with the Order object instance.

CriticalDates 614—CriticalDates is the embedded CriticalDates logical object associated with the Order object instance.

Attributes 616—Attributes is the embedded Attributes logical object associated with the Order object instance.

Update 618—Update is an optional embedded logical object containing the XPath's for the elements that have been updated, inserted or deleted for this logical object.

Contract Negotiations at the Hub

The system 300 permits the automatic reconciliation of contracts in a value chain. A service provider is notified when the contract under negotiation contradicts with other downstream contracts that it has with other partners. For example, in the case where the service provider B is negotiating a contract with service provider A for providing certain services to service provider A and that service provider B needs certain services from service provider C in order to provide its services to A. In this case, the contract between B and C must be sufficiently comprehensive so that B can comply the terms and conditions in its contract with A. The system 300 knowing all the relevant upstream and down stream contracts, for both parties, and knowing all the business rules (as explained above) provides the intelligence to compare and reconcile those contracts and present to the negotiating members with the necessary actions that need to be taken.

For automatic reconciliation and coordination of a provider's own contracts, when a partner or member starts negotiation of a new contract, modify or terminate an existing contract, the present invention checks all related contracts, verifies and analyzes the effect and alerts the member about any potential conflict. During the setup of the system or at a later time the system allows the partner to input verification criteria and analyses rules which are used at contract negotiation time.

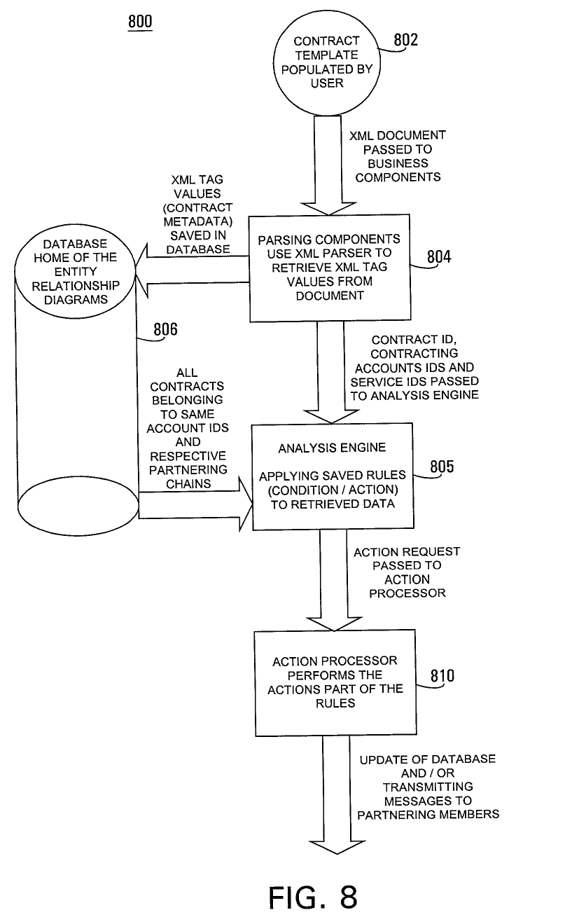

FIG. 8 is flow diagram 800 of the contract negotiations according to the present invention. Using the user interface 302 on partner system 202, the contract template based on XML is populated by the user, step 802. The order template is passed over network 104 to hub 106 for processing. The parser 340 extracts the contract metadata from the order template, step 804. The contract metadata includes contract clauses, contract critical dates, contract type, identification numbers of contracting parties, contract line items (services covered in the contract), and other attributes.

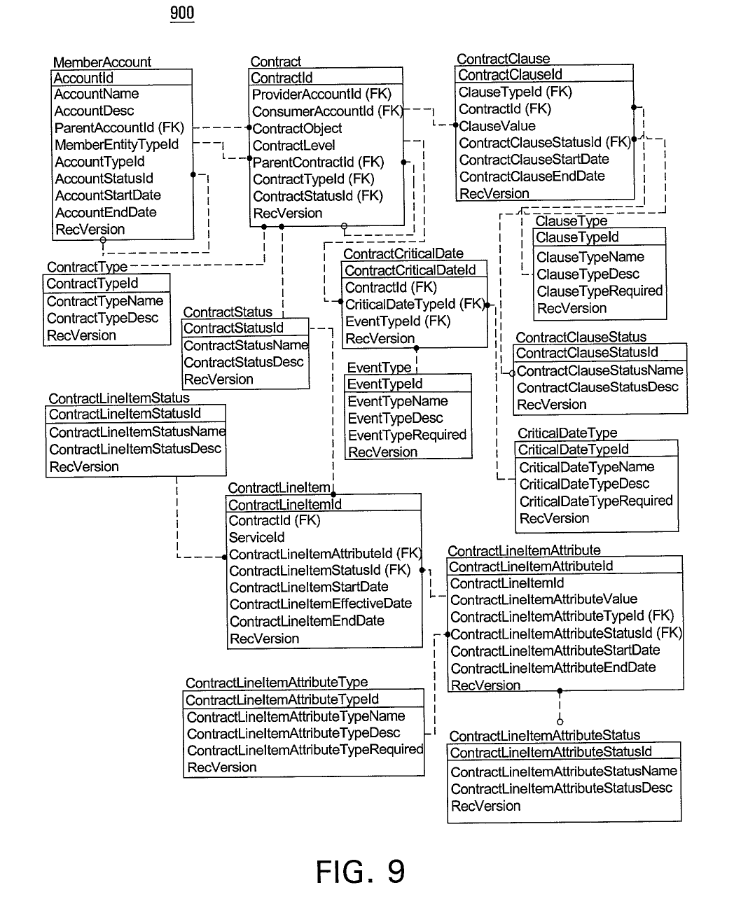

Using SQL the parser 340 saves the information retrieved from the XML contract template into the database 370, step 806. The schema of the database is shown in FIG. 9 and discussed in further detail below.

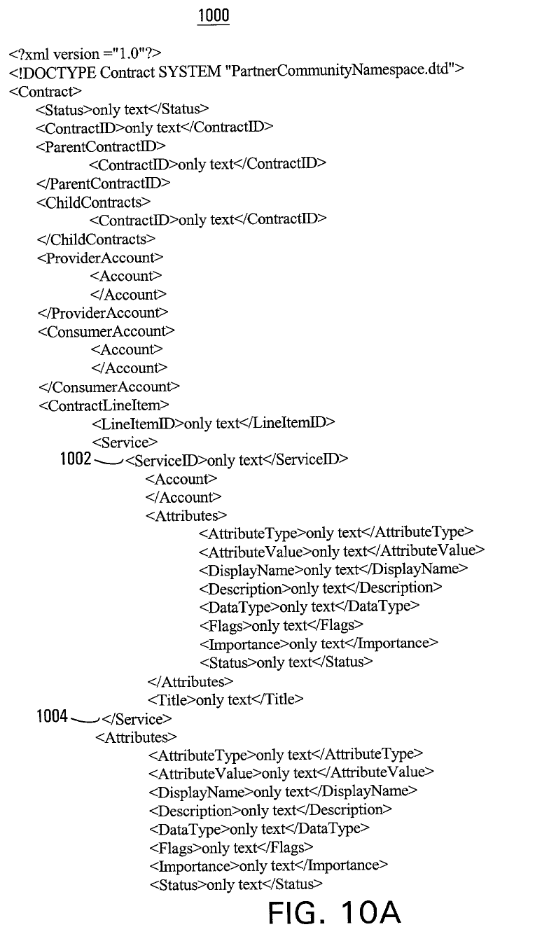

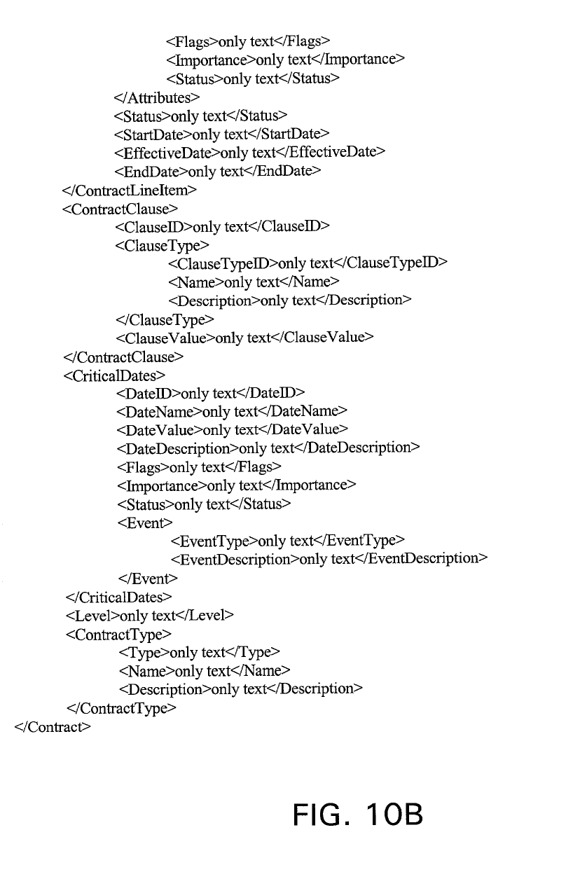

An identical naming convention is used in the XML document structure and the database 370 entity relationship diagram as shown in FIG. 10. Those of average skill in the art understand the map the data (tag values) from the XML document into table rows in the database. For example, the values of the XML tags ProviderAccountId 1004 and ConsumerAccountId 1006 under the tag Contract 1002 in the XML document contain the values, mapped into the columns ProviderAccountId and ConsumerAccountId in the Contract table in the database. The same principle applies to the values of the other tags in the XML document.

The parser components pass the ContractId 1002, contracting parties Ids (1004 and 1006) and serviceIds 1020 to the data and rules analysis 340. The tag naming in the XML document clearly identifies those Ids. Using the contracting parties Ids (1004 and 1006) the data and rules analysis engine 340 retrieves all the contracts related to the same service Id and belonging to the parties with the same account Id, step 808. It should be understood that the data and rules analysis engine 340 could also retrieve all contracts by other parties in that already established contracts with 1004 and 1006. The data and rules analysis engine 340 applies rules that were previously configured by the contracting parties and passes the required actions to the action processor 350.

In step 810 the action processor performs the actions based on the request of the data and rule analysis engine 340. The action processor may use other applications for the completion of the required actions. An example application is an e-mail server like Microsoft Exchange. So, the action processor forms the messages and passes it to the email server to send.

For streamlining the contract generation this invention enables members to use contract templates, fill it, address it, sign it and save it. Contract clauses are automatically generated through two procedures. First one is based on member preferences and association of clauses with template tags. Contract templates are saved in the database 372 at the system setup time. The contract schema, presented in FIG. 9, is used for saving the template contracts. The contract type in the contract schema indicate template. The second is based on system suggested clauses learned from member's past history. Suggestions or alternative clauses are those used by the negotiating partner in previous contracts. All clauses are saved in the database 372 as shown in the schema of FIG. 9.

For the contract negotiation of service contracts the action of save a contract triggers the negotiation process sending the contract to the addressed party. In the simplest scenario the addressed party adds or modifies clauses to the document and save it. The saving process presents the document to the originating party highlighting the changes. This process repeats until the two parties agree on the terms; in which case the final signed document will be saved for future monitoring and addendums and a set of configuration procedures (provisioning) takes place that allows the originating member to have access to items listed in the contract.

In another embodiment, the originator embeds controls into the original document. Those controls act as decision points that will help facilitate the negotiation process. The controls are either carried as part of the document or sent separately. One control produces satisfactory results is scripts embedded in HTML pages. A popular such control is used to prevent users of web pages to go forward if certain fields are not populated. In our case, an example of embedded controls is to put limits on prices so that if the addressed party changes the price to be higher than the limit the control will notify the member that this price is not acceptable.

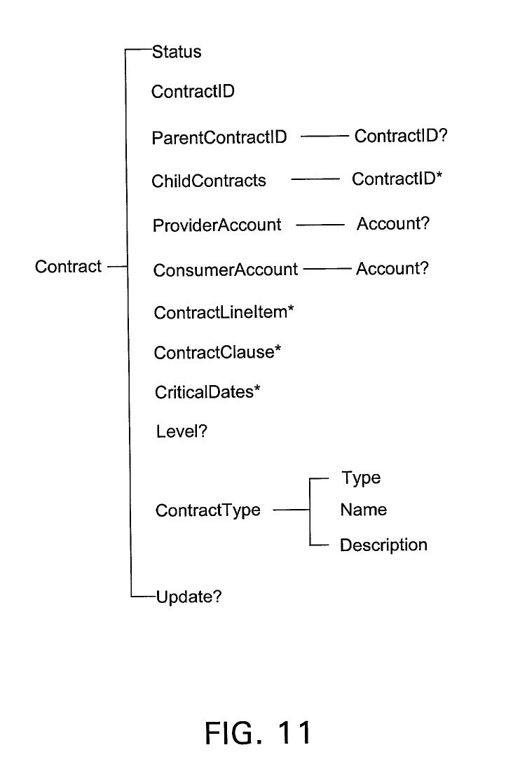

During contract negotiation the hub 106 processes contracts to automatically reconcile and coordinate related contracts in a value chain. In support of this processing a schema 900 is provided as shown in a template XML contract shown in FIG. 10 and the explanation of the tags given in FIG. 11.

The schema 900 in FIG. 9 is saved in a relational database such as Oracle™, Informix™, DB/2™, or SQL server™. Returning to the example above, where A is reselling a service purchased from C to B. In this example A, B, and C are parties in a value chain or partners in a value chain. As a further illustration, for simplicity, suppose that partner A (network service provider) is negotiating to outsource a front office application from partner B (application service provider). Partner A is requiring certain application availability and a certain throughput. Partner B is contracting with partner C (Hosting service provider) to provide hosting of partner B's applications. In this example, partner B is negotiating a contract with partner A for providing certain services to service partner A and that partner B needs certain services from partner C in order to provide its services to A. In this case, the contract between B and C must be sufficiently comprehensive so that B can comply the terms and conditions in its contract with A. In this exemplary explanation, it is assumed that partner A (network service provider) is negotiating to outsource a front office application from partner B (application service provider). Partner A is requiring certain application availability and a certain throughput. Partner B is contracting with partner C (Hosting service provider) to provide hosting of partner B's applications.

Sequence of Contracts Between Partners

1. Provider B (application service provider) negotiates a contract with provider C (hosting service provider). In this contract Provider C provides hosting of front office application for provider B. A complete copy of the contract will be saved at the hub 106. The hub 106 saves a set of metadata about the contract in database 372. Example metadata is availability metrics and measures.

2. After negotiating a contract provider B accesses the Hub through the interface 302 such as a GUI (graphical user interface) and associates rules with the negotiated contracts. Those rules are based on the metadata captured and are saved in the data transformation 330. Those rules will be applied later during the negotiation of the second contract in step 3 below.

3. Provider A (network service provider) negotiates a contract with provider B. During this negotiation the hub 106 references the contract metadata saved in step one above to guide, notify and alert the negotiating members of any inconsistency or risks in the terms being negotiated. The flow of the contract negotiation in step three above is as follows:

a) Provider A starts with a contract template provided by the hub 106. This template can use different formats. Example formats are (1) formatted Microsoft Word document with headers specifying the contract clause titles, or (2) an XML document with tags used to specify the content of those tags. The XML format is the preferred format for this invention.

b) Provider A edits the contract clauses (the content of the named tags). A method of editing the contract clauses, using XML as the format, is an XSL style sheet. The style sheet presents the clauses as edit boxes that can be edited by the user. In one embodiment, a style sheet is used to keep track of the edit history in audit trail 374.

c) Provider A submits the contract to provider B through the Hub 106. In one embodiment, implementation of the submission action is an HTTP post or a message with the XML as the body with message formats using the Electronic Business XML (ebXML) initiative technical framework (see online URL www.ebxml.org for more information).

d) At the Hub 106 the message is first decrypted in data transformation 330. The parser 340 is used to retrieve the contents of specific XML tags . Those are the tags that describe the metadata of the contract. Then, SQL is used to insert this metadata into a database 370. The data and rules analyzer 350 using the contract identification of the contract under negotiation will retrieve related information from database 372.

e) The analysis engine applies the rules captured in step 2 of the contract sequence above. Then, calls processing action 360 for processing a specific action. An example rule is:

If service type is front office

Check all contracts containing line item hosting and line item attribute front office

If found

Compare line item hosting and line item attribute availability with availability under negotiation

If larger

Do action

If smaller

Do action

It will be understood to those of average skill in the art, that a rule related to throughput is typically more sophisticated; because the rule will take into account all partner B's outsourced contracts that are based on partner's C hosting contract.

Other rules include pricing advise partner B to the limits that partner B can negotiate and the effects of changing the rate.

“If service type is front office

Check all contracts containing line item hosting and line item attribute front office

If found

Compare line item hosting and line item attribute availability with

availability under negotiation

If larger

Do action

If smaller

Do action”

Turning now to FIGS. 10A and 10B are a template XML of the contract tags used along with the contract entity schema of FIG. 9, according to the present invention. The XML contract 1000 follows the rules of XML where each item starts with an opening tag 1002 and a closing tag 1004 where the convention is the closing tag 1004 has the identical name preceding by a “/” in this example the opening tag 1002 is “service” and the closing tag 1004 is “/service”.

FIG. 11 is a tree diagram 1100 of the XML contract tags in FIG. 10, according to the present invention. The elements in the tree diagram are defined as follows:

Status 1104—Status is one of a list of possible states associated with the ContractLineItem (New, Deleted, Changed, Invalid, Owner, . . . ).

ContractID 1106—is the numerical unique identifier for the Contract object instance.

ParentContractID/ContractID 1108—is the numerical value for the ContractID of the parent contract, if any, of the Contract object instance.

ChildContracts/ContractID 1110—contains a list of ContractID's which are the numerical values for the ContractID's of the child contracts, if any, of the this Contract object instance.

ProviderAccount/Account 1112—is the embedded Account logical object associated with the Provider account for this Contract object instance.

ConsumerAccount/Account 1114—is the embedded Account logical object associated with the Consumer account for this Contract object instance.

ContractLineItem 1116—is the optional and repeatable embedded ContractLineItem logical objects associated with the Contract object instance.

ContractClause 1118—is the optional and repeatable embedded ContractClause logical objects associated with the Contract object instance.

CriticalDates 1120—is the optional and repeatable embedded CriticalDates logical object associated with the Contract object instance.

Level 1122—is the numerical value based on 0 of the level from the top contract in the hierarchy of contracts to the Contract object instance.

ContractType 1124—is the embedded logical object containing the name, type and description of the type of contract associated with the Contract object instance.

ContractType/Type 1126—is the numerical unique identifier for the ContractType object instance.

ContractType/Name 1128—is the Contract Type name of the Contract object instance.

ContractType/Description 1130—is the Contract Type description of the Contract object instance.

Update 1132—Update is an optional embedded logical object containing the XPath's for the elements that have been updated, inserted or deleted for this logical object.

Multiple Interpretations of Contracts

In one embodiment the contract is formed as previously described above in the section entitled “Contract Negotiations at the Hub”. In an alternate embodiment, the contract negotiation follows a traditional manual process and the resulting contract is entered into the system 300 using client connector 310 residing on each of the partner's systems 102. In one embodiment client connector 310 includes only a browser based GUI 302 that communicates directly with a web server at the hub 106. Regardless of the method the contract is entered into the system 300, each user can select to associate a set of metadata with contracts he is a party to. It is important to note that the contract, metadata association is on a per user basis. In other words, the metadata entered by one of the parties to a contract is owned by her and is not related to other parties to the same contract. Accordingly, in this embodiment, each partner or party to a contract has the option to associate it's set of clauses, critical items, and critical dates with any contract they are a party to. The system 300 enforces access privilege, allowing each of the parties to only see, add, or modify his own set of metadata. The metadata for association can include contract clauses, critical items and critical dates. An example critical date is the contract start date. An example contract clause is “Term”. The term description could potentially be few paragraphs. Exemplary critical items associated with Term are duration, which is a number, and renewable, which is a Boolean. Duration indicates the length of the contract starting form contract start date. Renewable indicates whether the contract is renewable or not. Defining critical items in this manner enables the system 300 at the hub 106 to manipulate and apply conditions and criteria to those critical items.

The graphical user interface 302 of client connector 310 allows users to add rules to contracts. Rules are based on the critical items associated with a contract. Example rules associated with contracts are:

10 days before the end of the term send an e-mail reminder.

At the end of the contract (start date+term) if the term is not renewable reject all orders for services covered in this contract.

The system 300 at the hub 106 implements and enforces the rules on behalf of each user partner.

The graphical user interface 302 passes a document containing the contract metadata into Parser 340. The Parser 340 extracts and inserts the contract metadata and rules into the database 372. Next, the Parser 340 passes the contract ID to component Data and Rules Analysis engine 350. The Data and Rules Analysis engine 350 checks the rule conditions and call the Action Processor 360 to execute the associated actions. Any actions that need to be executed at a later time are scheduled into a queue in the database 372. At the appropriate time a continuously running scheduler passes over the scheduled task to the action processor for execution.

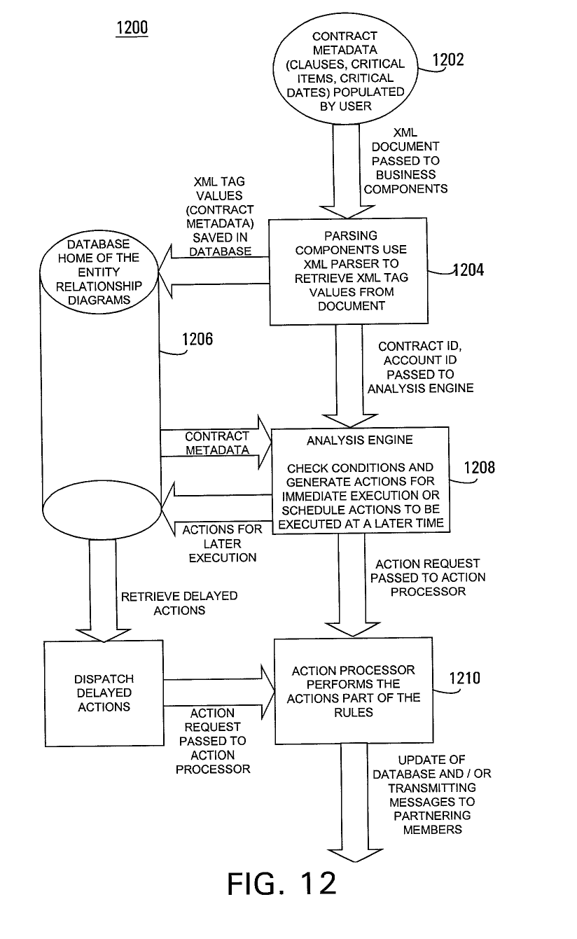

FIG. 12 is a flow diagram 1200 of managing multiple interpretations of a single contract, according to the present invention. The process, as previously described above for FIG. 4 and FIG. 8, uses the user interface 302 on partner system 102. The contract template is based on XML and is populated by the user, step 1202. The contract template is passed over network 104 to hub 106 for processing. The parser 340 extracts the contract metadata from the contract template, step 1204. The contract metadata includes contract clauses, contract critical dates, contract type, identification numbers of contracting parties, contract line items (services covered in the contract), and other attributes.

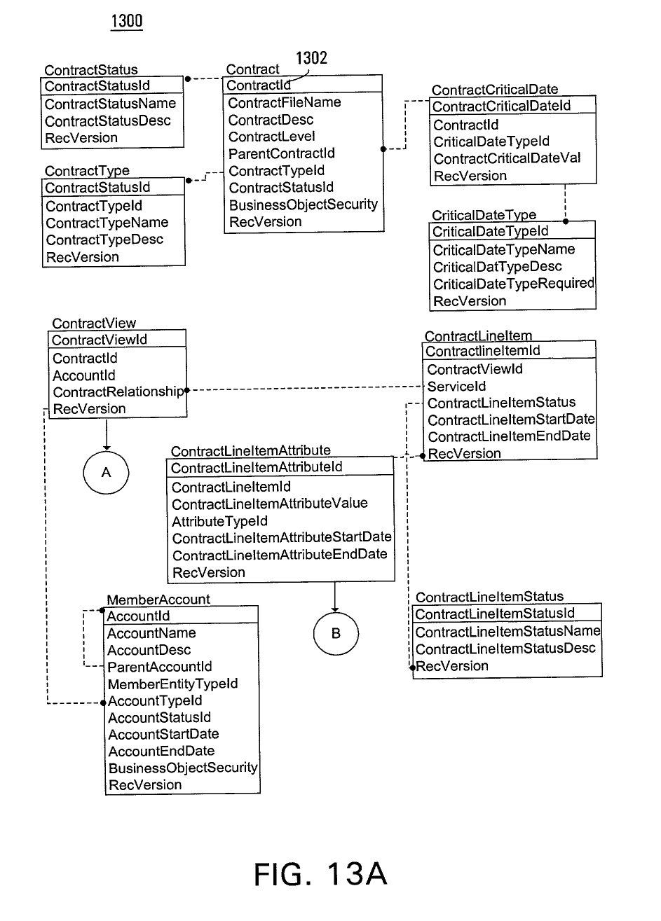

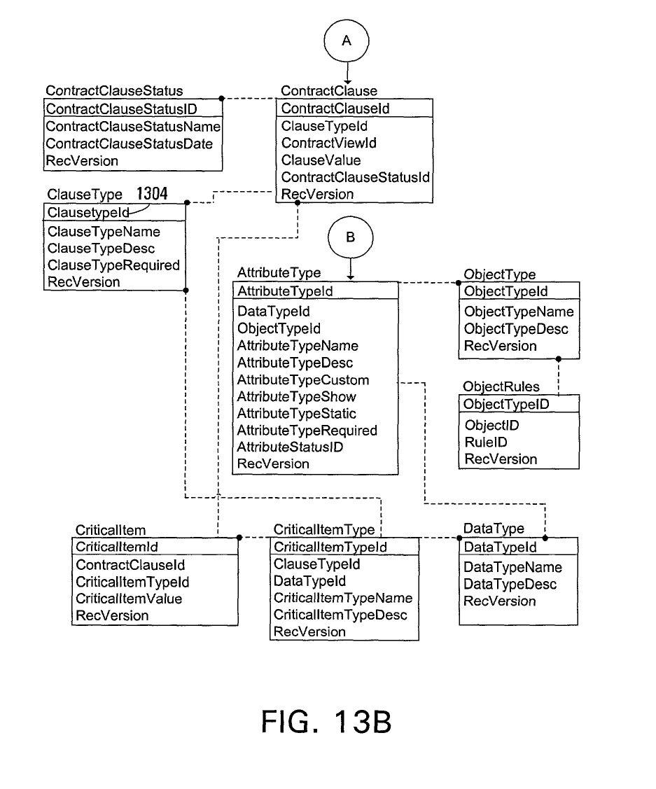

Using SQL, the parser 340 saves the information retrieved from the XML contract template into the database 370, step 1206. A schema of the database to support the contract and contract metadata is shown in FIGS. 13A and 13B , according to the present invention.

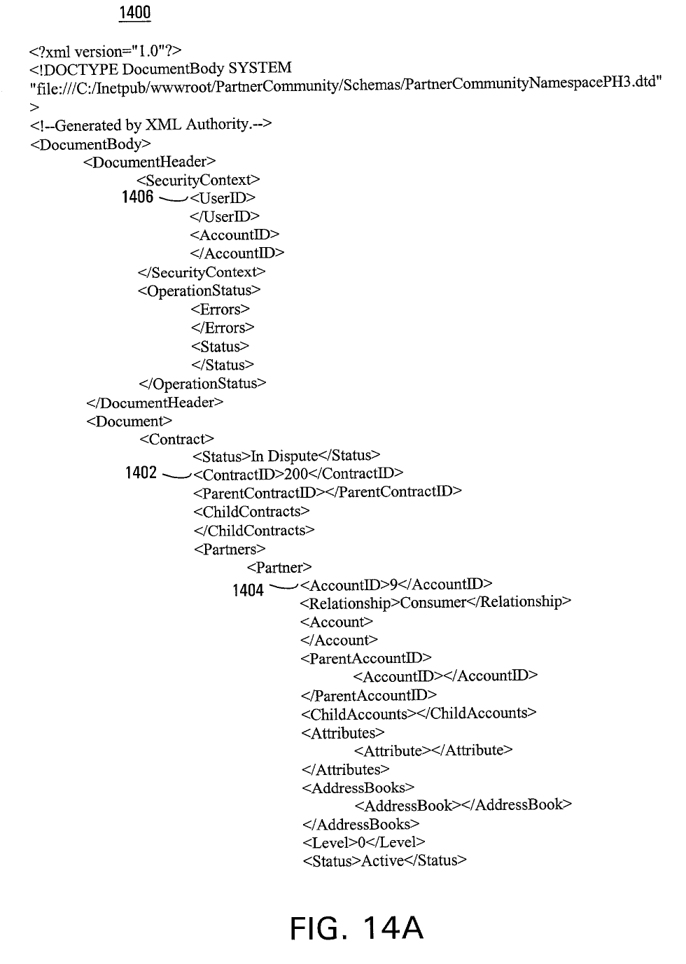

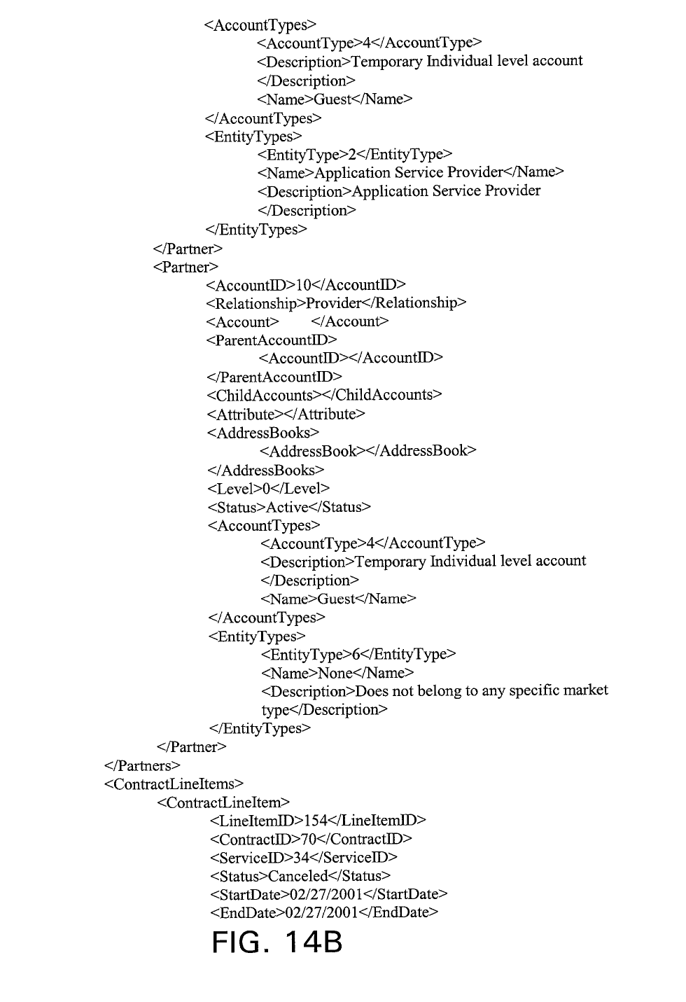

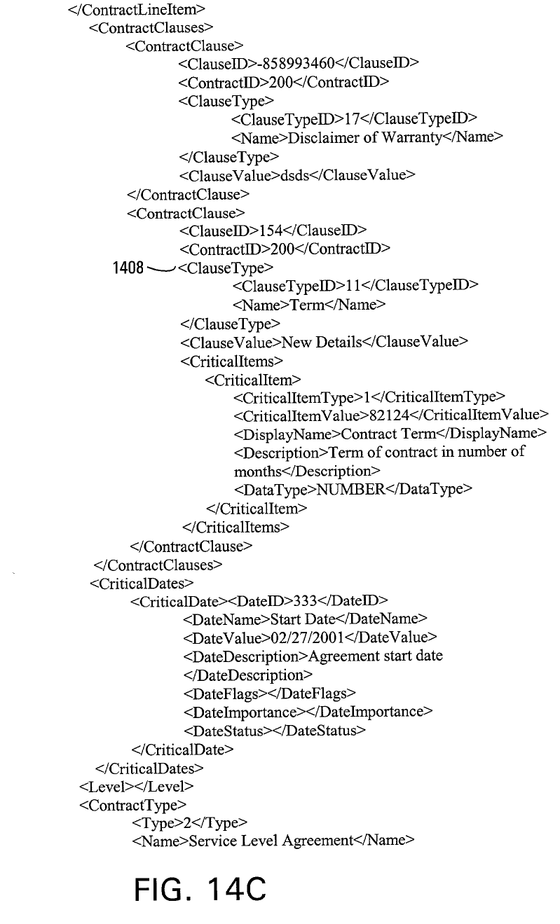

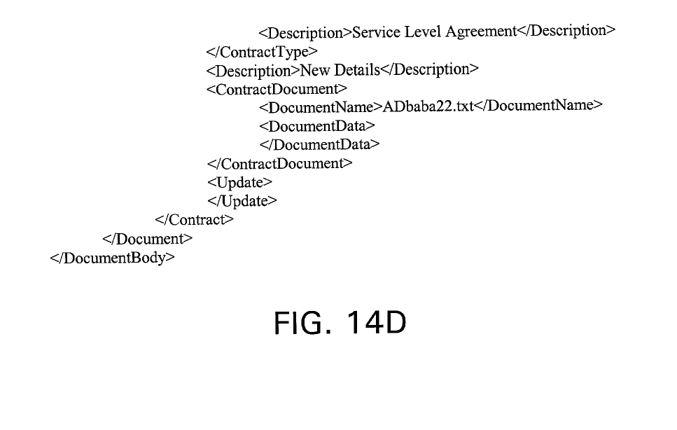

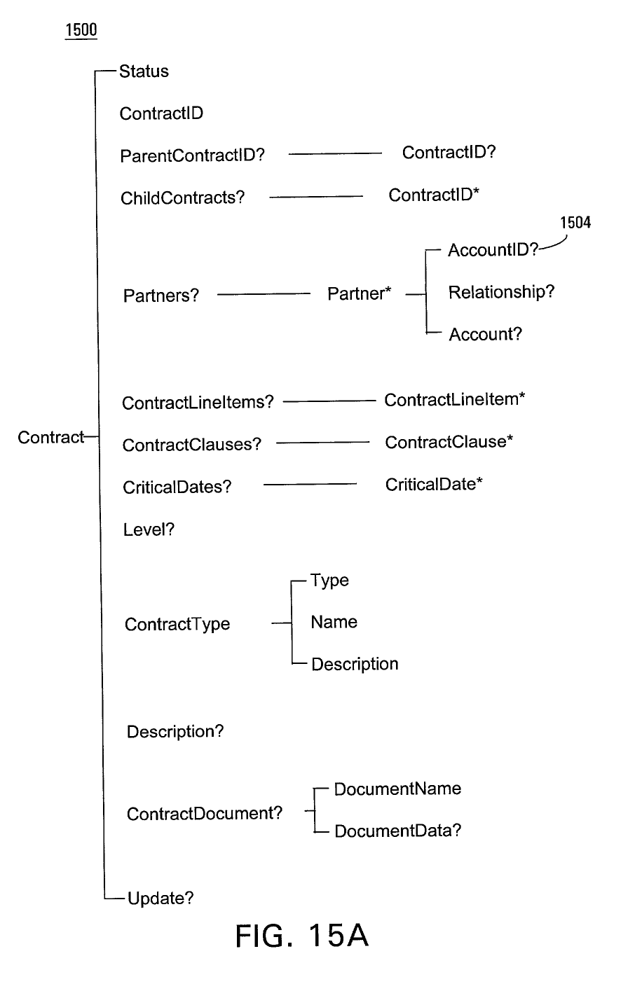

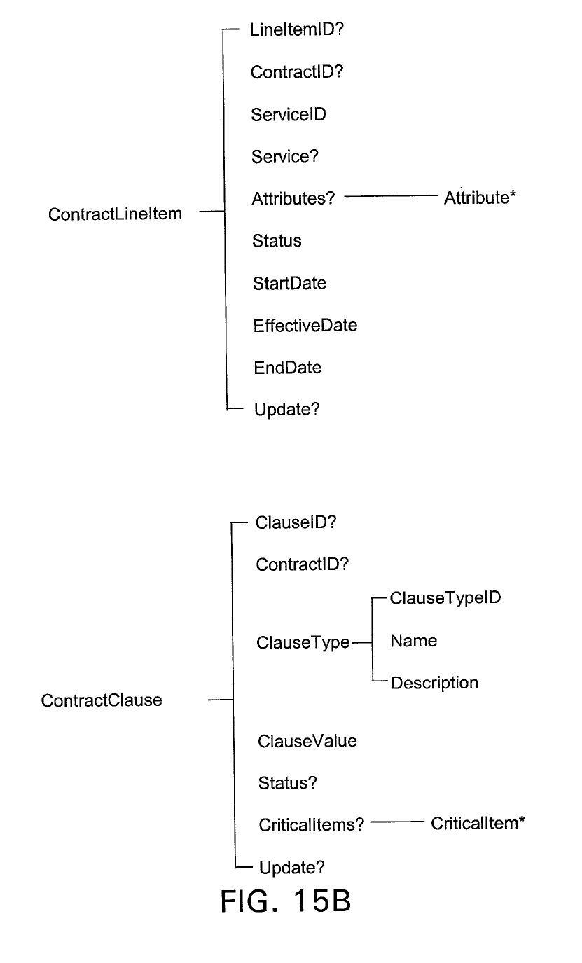

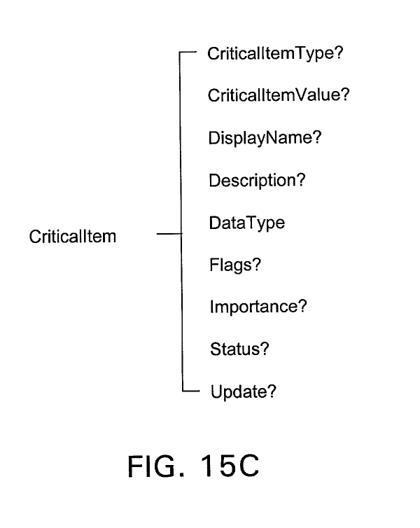

A template of the XML contract tags used along with the contract entity schema of FIGS. 13A and 13B, are shown in FIGS. 14A, 14B and 14C. And a tree diagram of the XML contract tags in FIG. 14A-C is shown in FIG. 15, according to the present invention.

An identical naming convention of database schema 1300 is used in the XML document structure and the database 370 entity relationship diagram as shown in FIG. 15. Those of average skill in the art understand the map between the data (tag values) from the XML document 1400 and table rows in the database. For example, the values of the XML tag contractId 1402 and ClauseType 1406 in the XML document 1400 contain the values, mapped into the columns 1302 and 1304 in the database schema 1300 of FIGS. 13A and 13B. The same principle applies to the values of the other tags in the XML document.

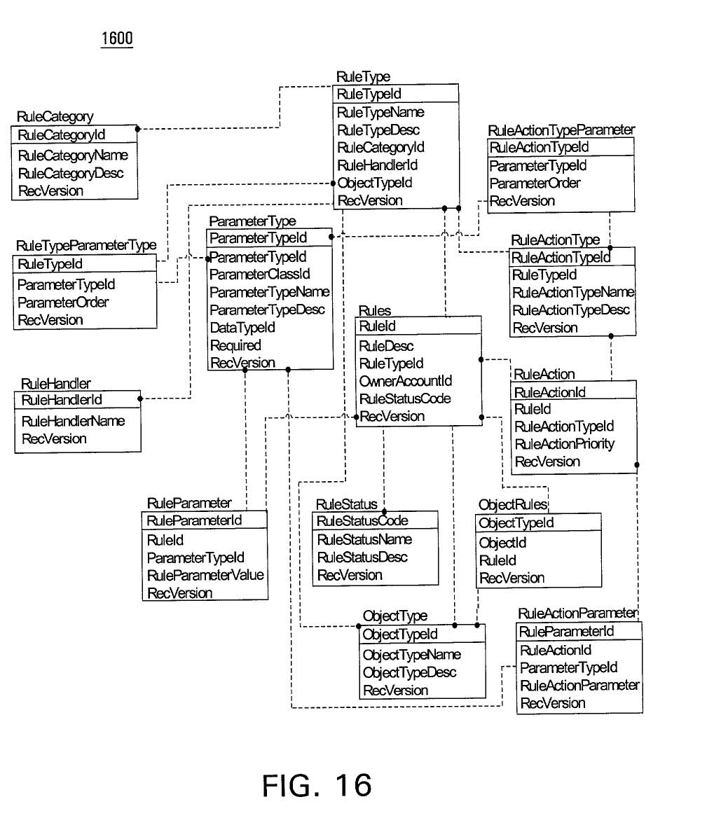

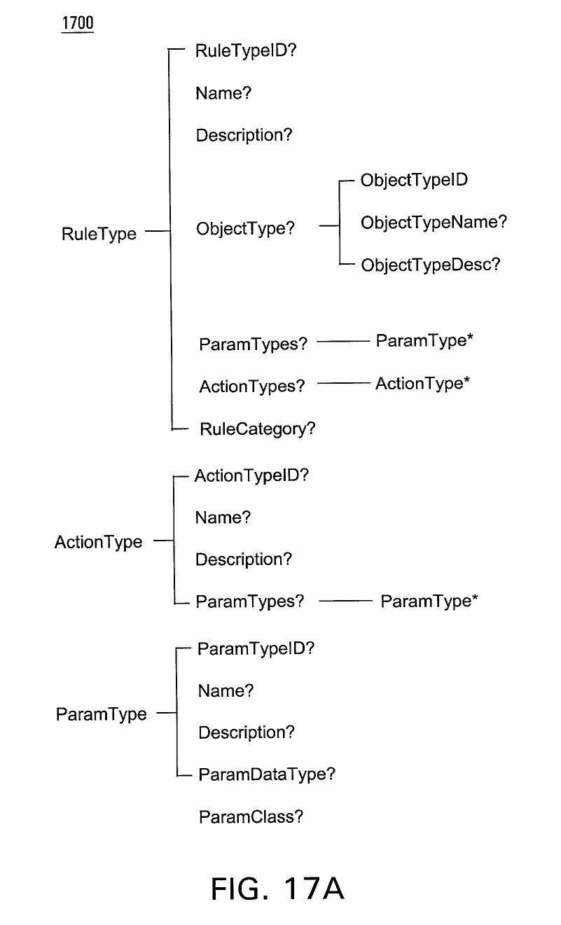

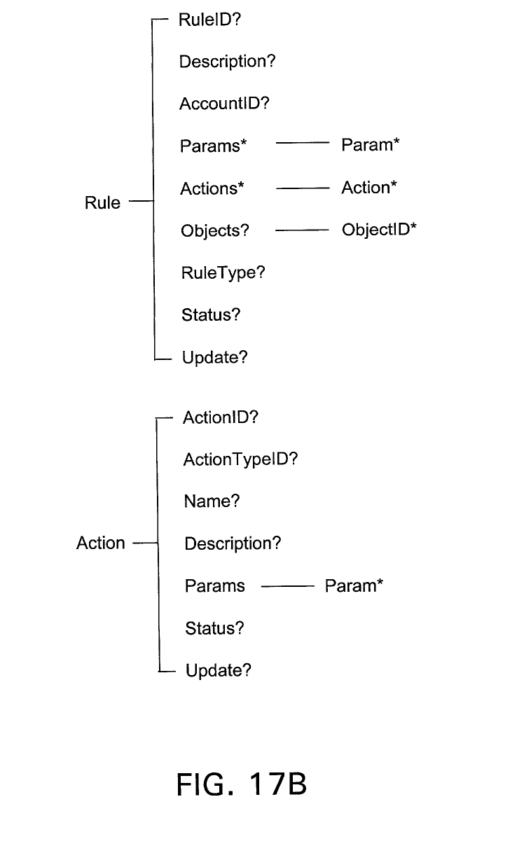

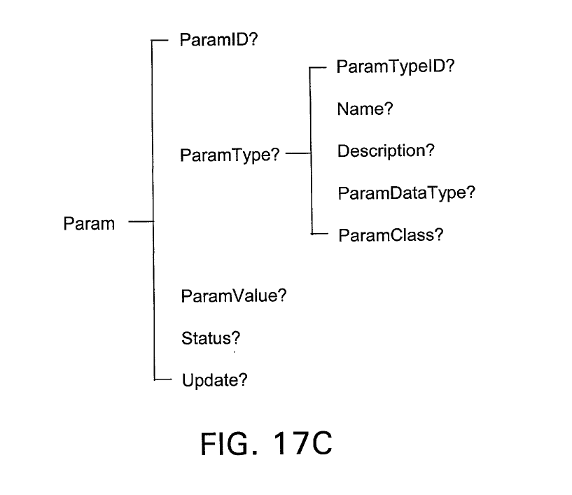

The parser passes the ContractId 1402 to the Analysis engine 350 in step 1402. Using the contract entity schema of FIGS. 13A and 13B the Analysis engine retrieves all the contract metadata, step 1208. Using the rule entity schema of FIG. 16, in specific the schema table “ObjectRules”, the Analysis engine retrieves all the rules, rule parameters, rule actions and pointers to rule handlers, step 1208. Note that the ObjectID in the schema table “ObjectRules”, in FIG. 16, represents the ContractId 1402.

The parser components pass the ContractId 1402 and AccountId 1404 to the data and rules analysis 350. The tag naming in the XML document clearly identifies those Ids. Using the ContractId 1402 and the AccountId 1404 the data and rules analysis engine 350 retrieves all the contract metadata belonging to the party with the account Id, step 1208. Also, using the rule entity schema of FIG. 16, in specific the schema table “ObjectRules”, the data and rules analysis 350 retrieves all the rules, rule parameters, rule actions and pointers to rule handlers associated with the ContractId 1402 and AccountId 1404, step 1208. The data and rules analysis engine 350 applies rules that were previously configured by the contracting parties and passes the required actions to the action processor 360.

In step 1210 the action processor performs the actions based on the request of the data and rule analysis engine 350. The action processor may use other applications for the completion of the required actions. An example application is an e-mail server like Microsoft Exchange. So, the action processor forms the messages and passes it to the e-mail server to send.

FIG. 15 is a tree diagram 1500 of the XML contract tags in FIG. 14A-C, according to the present invention. The elements in the tree diagram are defined as follows:

AccountID 1504—AccountID is account ID of the account that has the user entering the contract for the Contract object instance.

UserID 1506—UserID is the user that is entering the contract for the Contract object instance.

ClauseID—is the numerical unique identifier for the ContractClause object instance.

Instances: MIN: 0 MAX: 1

ClauseType—is the embedded logical object containing the name ID and description of the type of clause associated with the ContractClause object instance. Instances: MIN:

1 MAX: 1

ClauseType/ClauseTypeID—is the numerical unique identifier for the ClauseType object instance. Instances: MIN: 1 MAX: 1

ClauseType/Name—is the Clause Type name of the ContractClause object instance.

Instances: MIN: 1 MAX: 1

ClauseType/Description—is the Clause Type description of the ContractClause object instance. Instances: MIN: 1 MAX: 1

ClauseValue—is the clause text value for the ContractClause object instance. Instances:

MIN: 1 MAX: 1

Status—Status is one of a list of possible states associated with the ContractLineItem

(New, Deleted, Changed, Invalid, Owner, . . . ). Instances: MIN: 1 MAX: 1

ContractID—is the numerical unique identifier for the Contract object instance and is FIG. 16 Instances: MIN: 0 MAX: 1

ParentContractID/ContractID—is the numerical value for the ContractID of the parent contract, if any, of the Contract object instance. Instances: MIN: 0 MAX: 1

ChildContracts/ContractID—contains a list of ContractID's which are the numerical values for the ContractID's of the child contracts, if any, of the this Contract object instance.

Instances: MIN: 0 MAX: 1

ContractLineItem—is the optional and repeatable embedded ContractLineItem logical objects associated with the Contract object instance. Instances: MIN: 0 MAX:*

ContractClause—is the optional and repeatable embedded ContractClause logical objects associated with the Contract object instance. Instances: MIN: 0 MAX: *

CriticalDates—is the optional and repeatable embedded CriticalDates logical object associated with the Contract object instance. Instances: MIN: 0 MAX: *

Level—is the numerical value based on 0 of the level from the top contract in the hierarchy of contracts to the Contract object instance. Instances: MIN: 0 MAX: 1

ContractType—is the embedded logical object containing the name, type and description of the type of contract associated with the Contract object instance. Instances: MIN: 1 MAX: 1

ContractType/Type—is the numerical unique identifier for the ContractType object instance. Instances: MIN: 1 MAX: 1

ContractType/Name—is the Contract Type name of the Contract object instance. Instances: MIN: 1 MAX: 1

ContractType/Description—Description is the Contract Type description of the Contract object instance. Instances: MIN: 1 MAX: 1

ContractDocument—is an optional embedded logical object containing the file name and ASCII encoded binary file for the contract. Instances: MIN: 0 MAX: 1

ContractDocument/DocumentName—is the Contract file name of the Contract object instance. Instances: MIN: 1 MAX: 1

ContractDocument/DocumentData—is the optional Contract file ASCII encoded data of the Contract object instance. Instances: MIN: 1 MAX: 1

Update—is an optional embedded logical object containing the XPath's for the elements that have been updated, inserted or deleted for this logical object. See the Update Logical Object. Instances: MIN: 0 MAX: 1

FIG. 16 is a database schema 1600 to support-associating rules with contracts as shown in FIG. 13, according to the present invention. And as described above for FIGS. 13-15, an identical naming convention of database schema 1600 is used in the XML document structure and the database 370 entity relationship diagram as shown in FIG. 16.

To streamline the contract and contract metadata entry this invention enables members to use contract templates, fill it, and submit the contract data. Contract clauses and critical items are automatically generated. One method is based on association of clauses with template tags. Contract templates are saved in the database 372 at the system setup time. The contract schema, presented in FIG. 13A, B, is used for saving the template contracts. The contract type in the contract schema implicate the template.

Screen Shots of User Definable Views Into a Contract

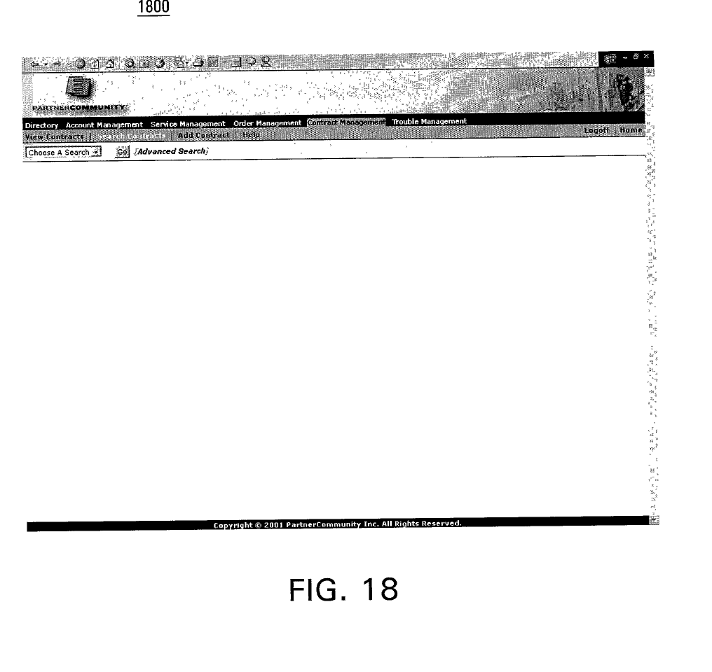

FIGS. 18-23 are a series of screen shots illustrating the customized interpretations of a contract, according to the present invention. In this exemplary embodiment, the user is logged in to the system 300 with a user ID and password. The information and screens are customized to the user ID. For example, an account administrator would only see account management. A purchase manager is authorized to see orders and how to place orders. A contract manger would see the contracts. FIG. 18 shows a screen for searching preexisting contracts.

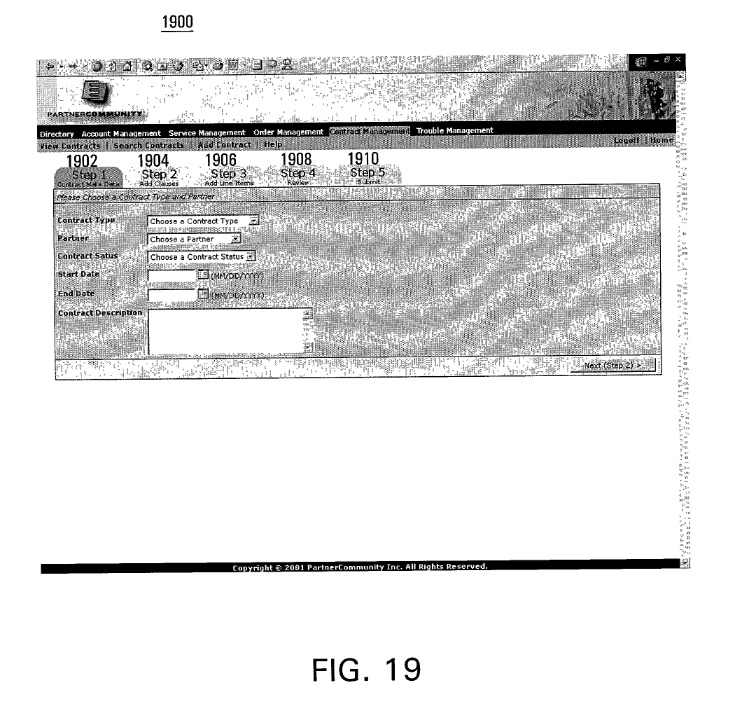

Next, in FIG. 19 shown is a display illustrating adding a contract and a specific view or interpretation. The contract has been previously negotiated and the logged in user is adding the contract and his interpretations into the system 300. That is, the critical terms and conditions (Ts & Cs) that the logged-in user deems are critical. It is important to note that this is not contract negotiation and the contract has already been completed, signed and executed by the contracting parties. Accordingly, a single contract can have multiple interpretations; not only for each party to the contract but also, based on the user authorizations. The system 300 in this embodiment manages all of the various interpretations or views into one contract.

In another embodiment, instead of having each logged in user enter the T's & C's that they deem critical, these data items are retrieved directly from the contract document itself using smart markup tags. Another method is to use standard templates for the contract, which the data is extracted from. For example, a business contract with one or more partners where the values in the contracts might be different, but the format of the contract is the same. One example is the term of a contract; the format is always the same from partner to partner but the number of months changes.

Returning to FIG. 19, five tags of STEP 1, STEP 2, STEP 3, STEP 4 and STEP 5 (1902-1910) are shown. In STEP 1, the type of contract is chosen. Then, the user is guided through STEPS 2, 3, 4 and 5 where clauses, line items, and critical items are added. The system 300 filters subsequent selections based on prior selections. This mechanism applies to contract types, clause types, critical items and rules.

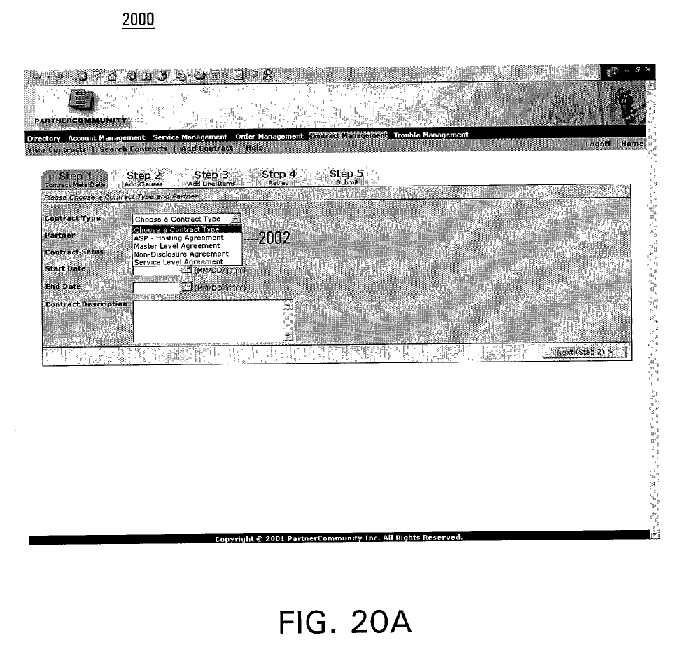

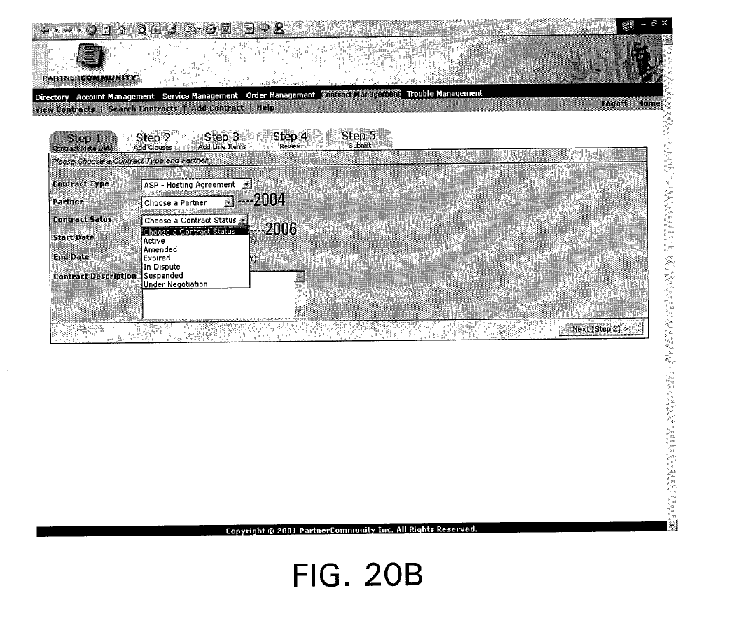

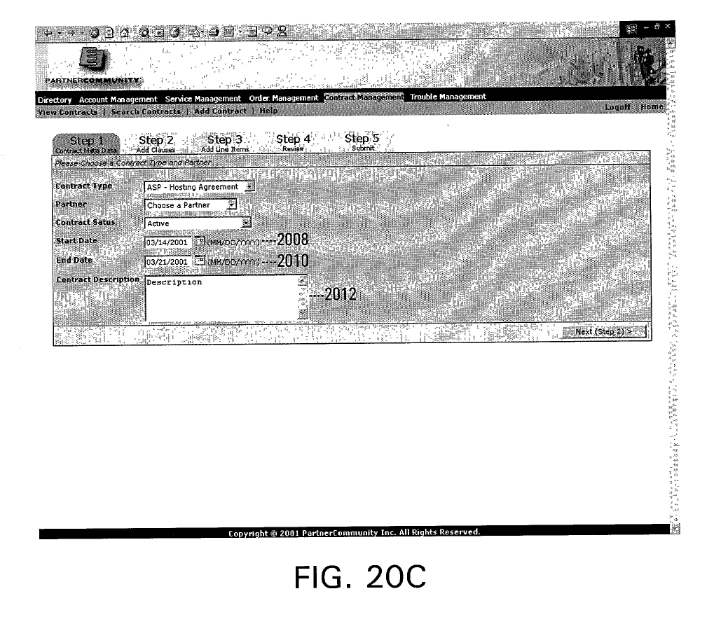

Shown in FIGS. 20A-20C are examples of the types of contracts 2002. Shown in this example are master level agreements, ASP hosting agreements, service level agreements, and non-disclosure agreements. In addition, in pull down 2004, the logged in user can specify who are the partners to this agreement. Status of the contract is also specified in drop-down 2006; example statuses are active, amended, and expired. The start date 2008 and the end date 2010 for monitoring the contract are also added. Optionally a description 2012 can be added.

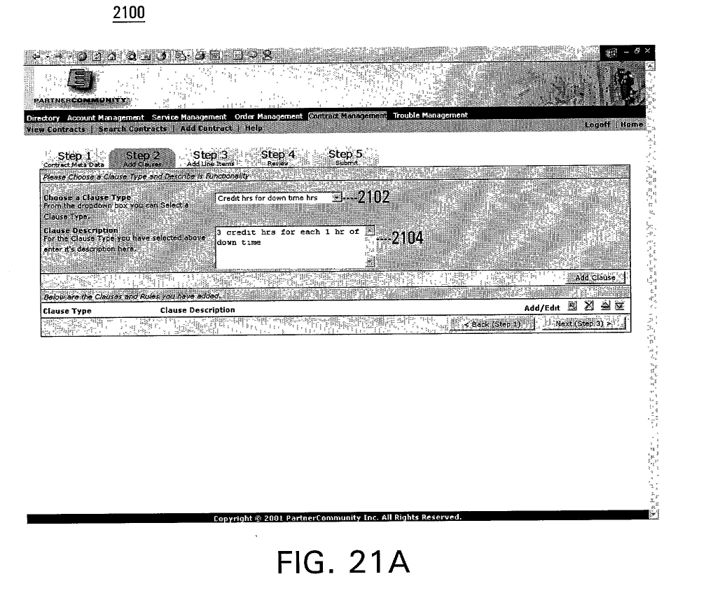

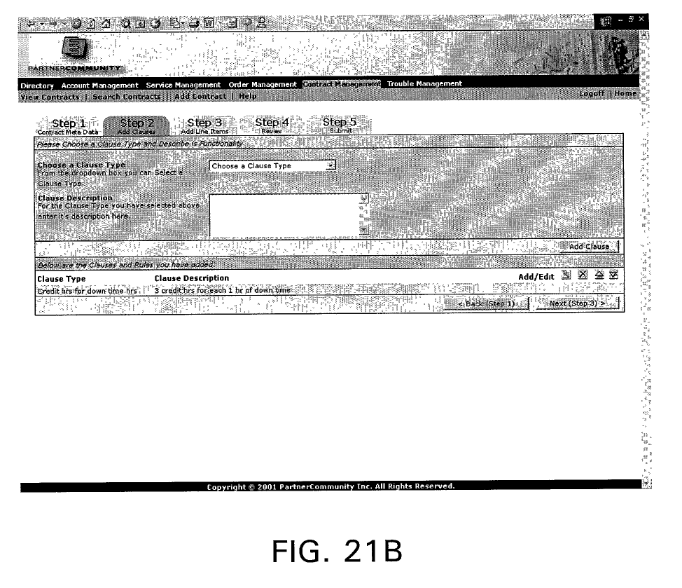

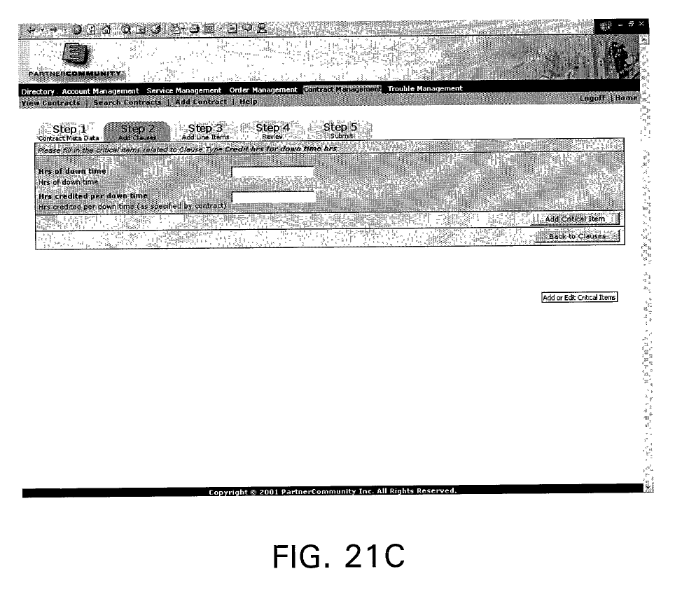

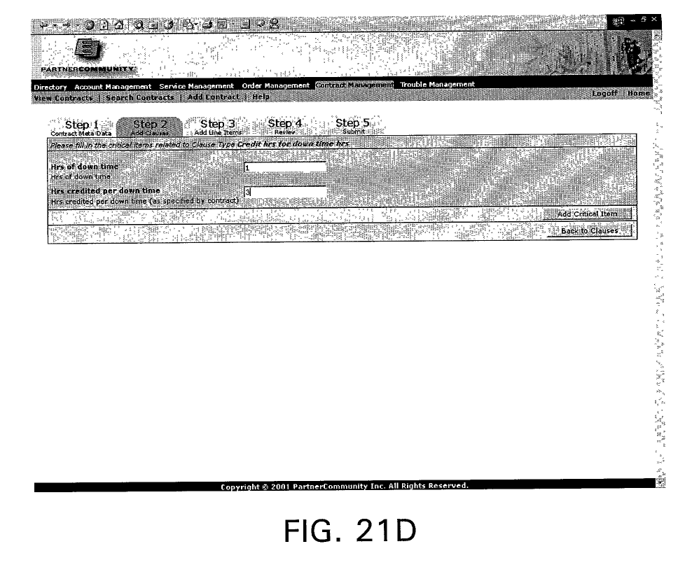

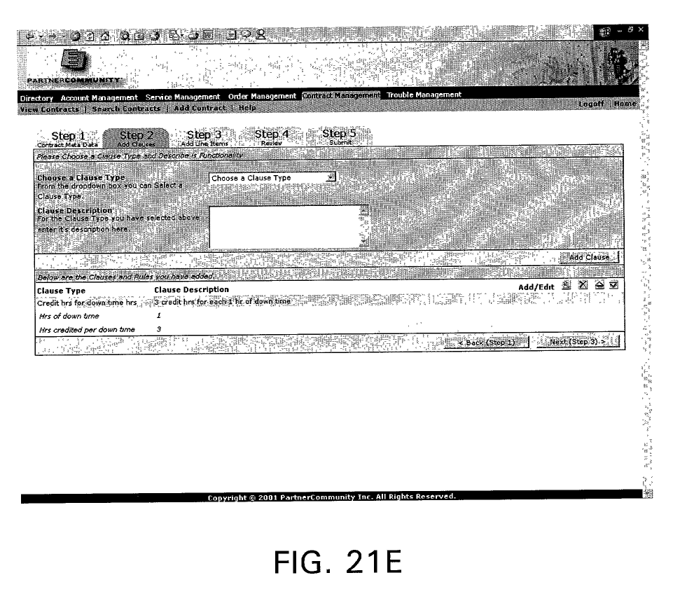

STEP 2 (1904) of the five steps is shown in FIGS. 21A-21E. In STEP 2 1904 a clause type is selected. Exemplary clause types are credit hours for down time hours, confidentiality clauses, equipment update clauses, fees, taxes and payment. In this example, credit hours for down time is chosen in drop down 2102. In this example, 3 credit hours for each one hour of down time is entered as description 2104. Then, the clause is added for monitoring for this logged in user.

Each clause added in STEP 2 1904 can be edited. Editing means changing the clause description and/or adding critical items to this clause. In our example, the critical items are the 3 and the 1. It is important to note that the user can control the entry of these numbers, e.g., the amount of down time and the credit per down time. This user customizable critical item is then linked to the clause. Other critical items can be added to the clause.

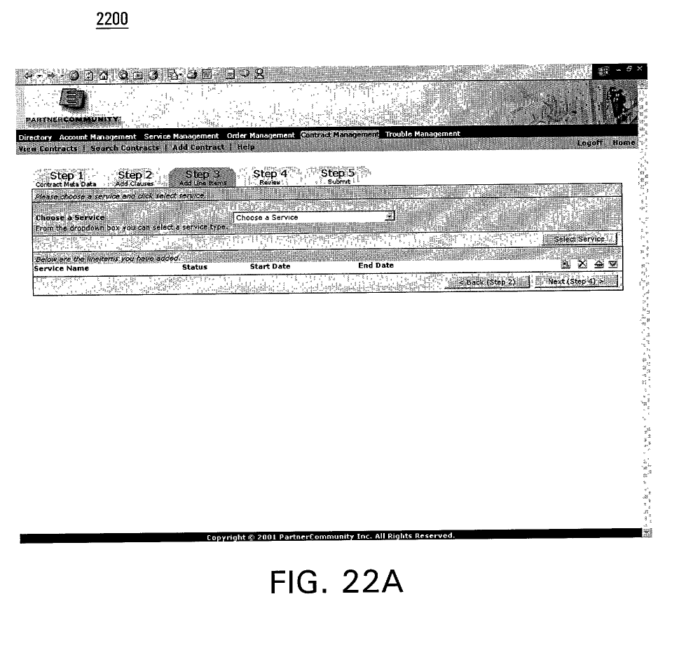

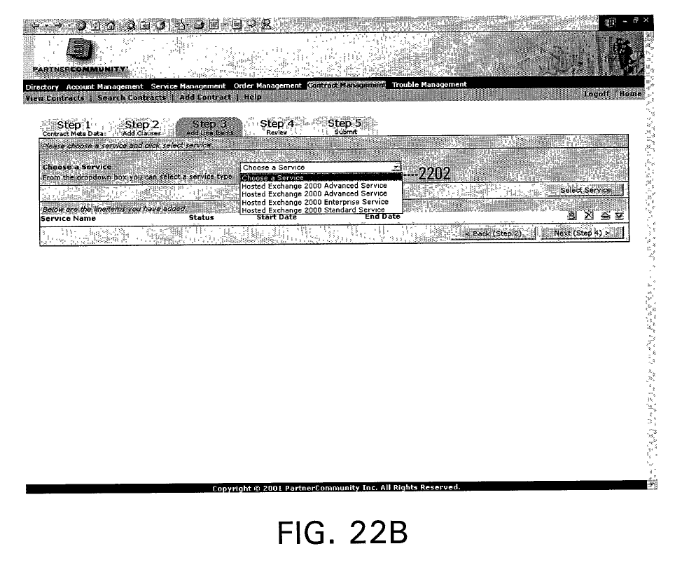

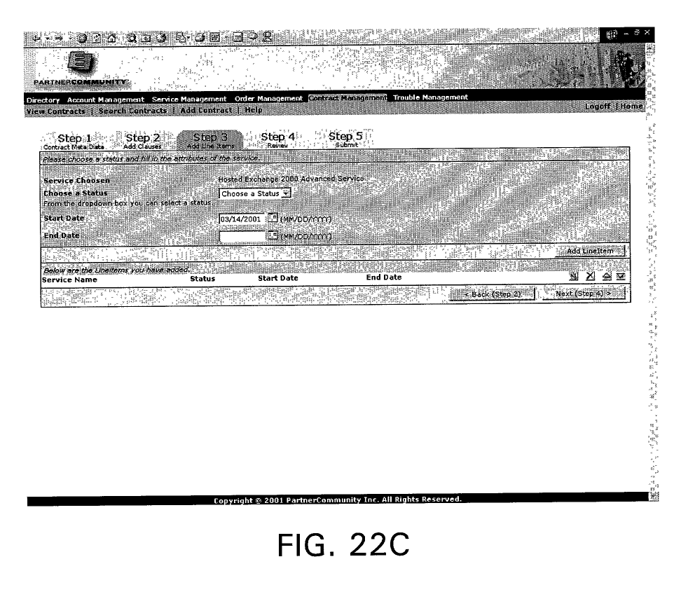

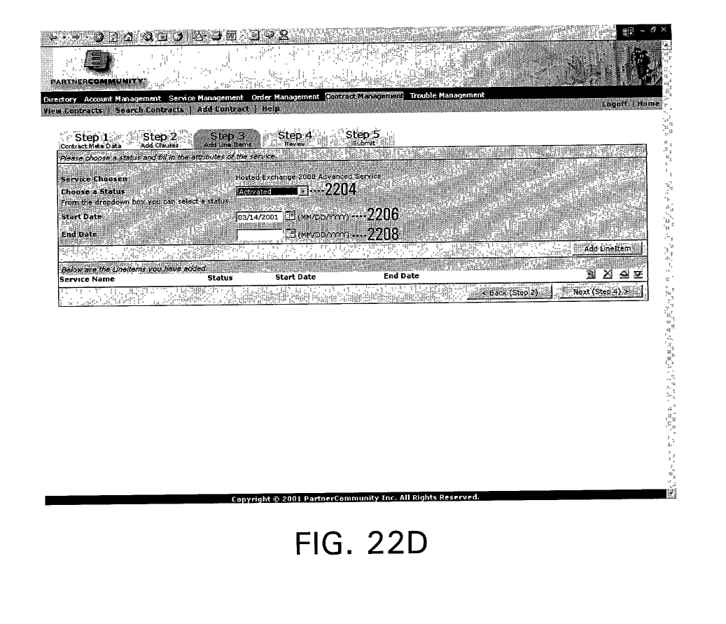

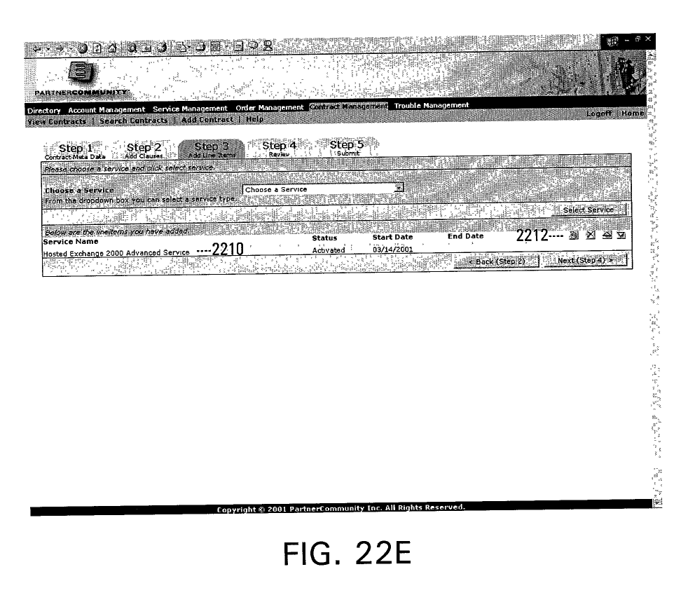

Turning now to FIGS. 22A-22E, details exemplary screen shots for STEP 3 (1906). Step 3, allows services that are covered by this contract to be specified. Specifying the service 2202 that is covered by this contract is shown in FIG. 22B, in this example Microsoft Exchange 2000 Advance Service is chosen. Services displayed are only those provided by partners as specified above in FIG. 19. Later the user can setup rules to link the orders of this service with the contract interpretation specified. For this service, a status of activated 2204 is selected. In addition, a start date 2206 and an end date 2208 are customizable for this service item. In one embodiment, the default start date 2206 is the start date of the contract. By allowing customizable start dates 2206, a contract starting today can have 2 or 3 services starting at different times. For example, one start date for a first service, say Web Hosting, begins immediately at the start of the contract while the start date for a second service, say e-mail POP accounts, begins three weeks after the start of the contract. The start date for each service is specified individually and each of the services is added to the logged in user's interpretation of the contract.

In FIG. 22E, the line item 2210 for the user is shown with the status, start date, and end date as filled previously along with a group of editing buttons 2212, for add, edit, and delete.

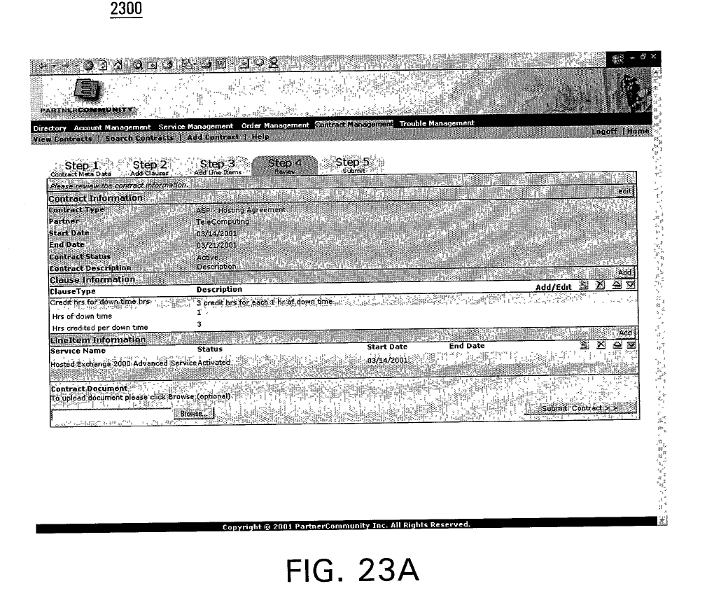

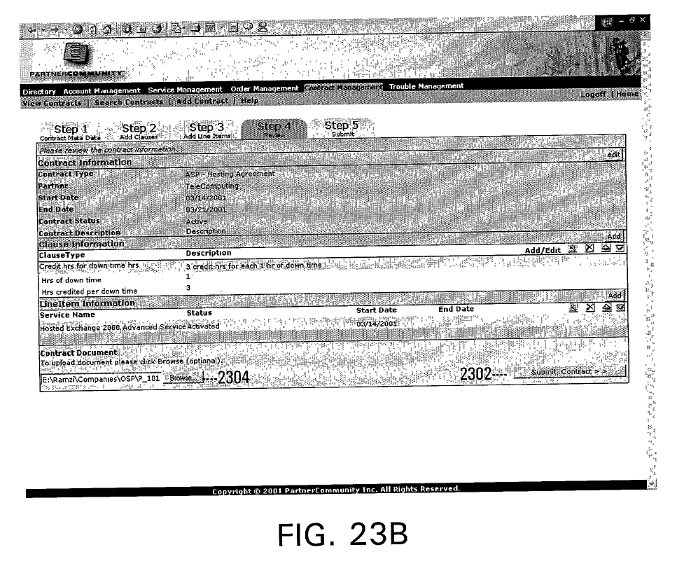

FIG. 23A and 23B are an exemplary screen shot 2300 for STEP 4 (1908). STEP 4 enables the user to review each item entered thus far, including contract information, contract type, partners, start date, end date, clauses and for each clause one or more critical items that the user wants to track. The name of contract file 2304 is entered on this screen. Hitting the SUBMIT Contract button 2302 places all of the data, including the contract file, into the system 300 database 370. In another embodiment, the information manually entered in this example is extracted from the contract itself so that several of the fields are automatically populated.

Using the present invention, a user can go one step further to associates rules with the contract just created. Alternatively, at any time, a user can log on to the system; select a contract; and then associate rules with the contract. In a third alternative a user can associate rules with more than one contract at a time.

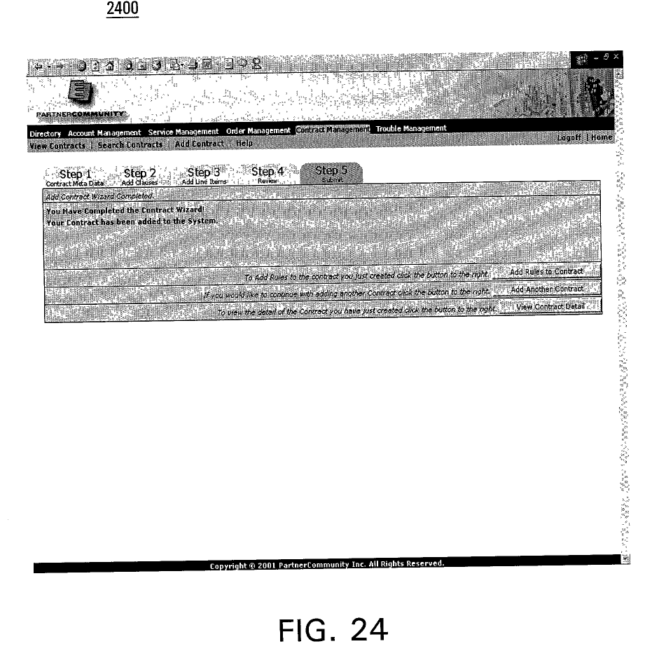

FIG. 24 is an exemplary screen shot 2400 for STEP 5. The user gets to STEP 5 after entering the contract, contract clauses, contract line items, contract critical items and reviewed all the entries. After STEP 5 the user can add rules to the contract. In this embodiment, adding a rule is divided into 4 sub-steps which guide the user into adding a rule. The rules displayed through the four sub-steps are shown in FIGS. 24A-24J. The rules are associated with the critical items described above. Accordingly, the system 300 filters the rules displayed by the critical items that were selected previously. It is important to note that more than one rule can be set for a given critical item.

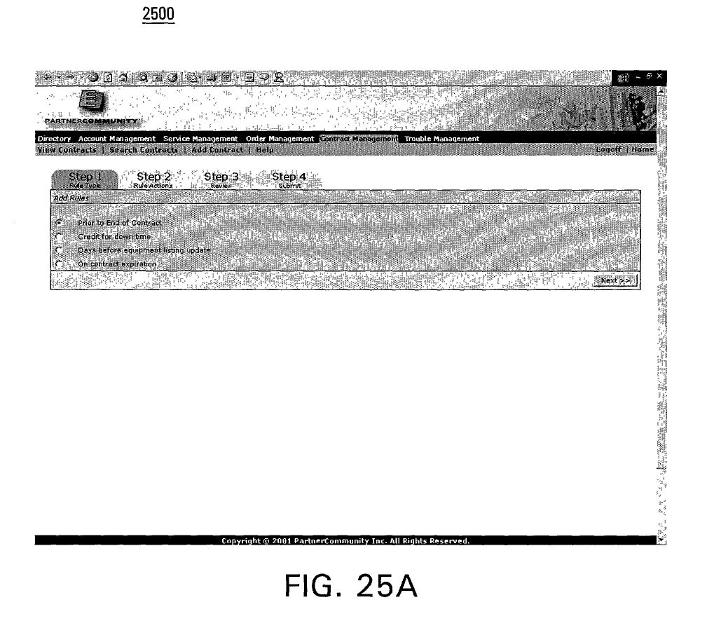

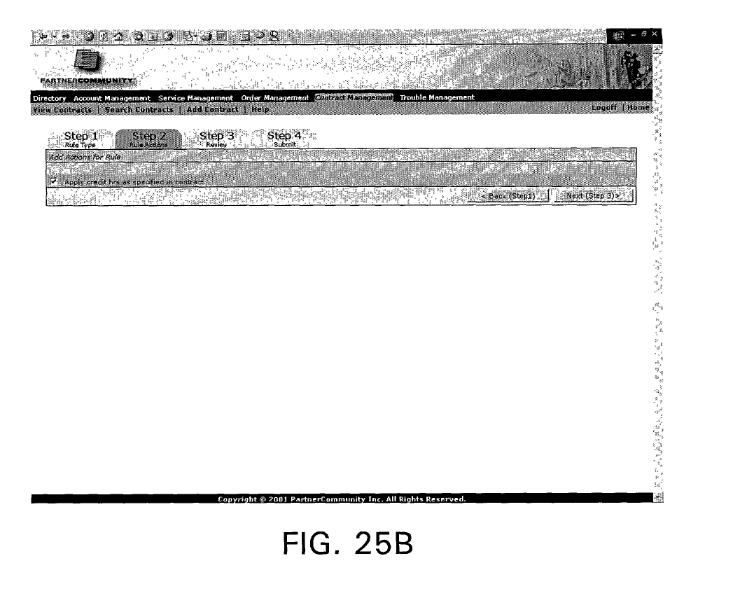

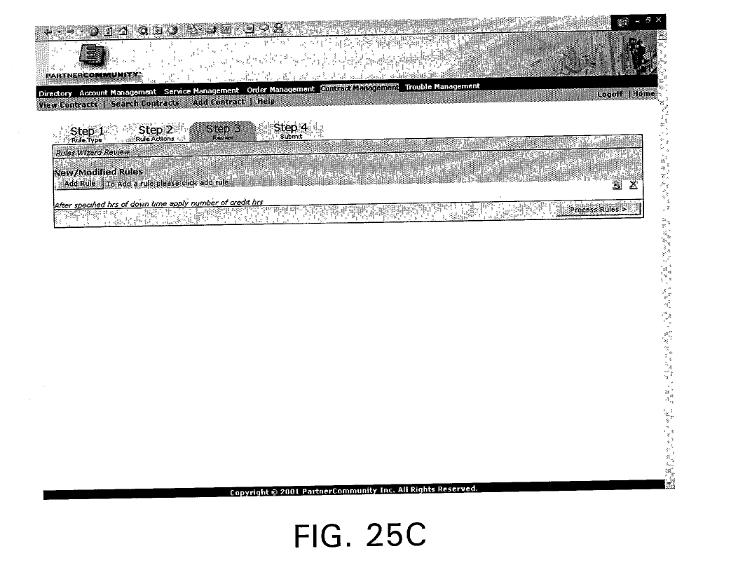

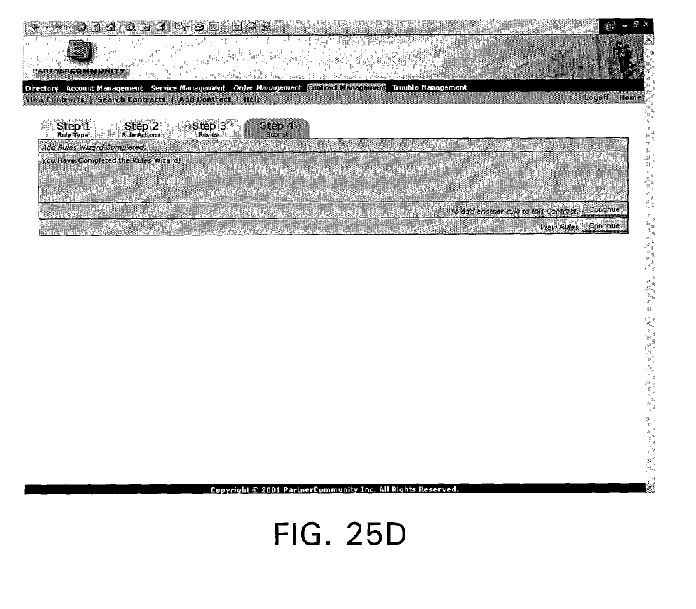

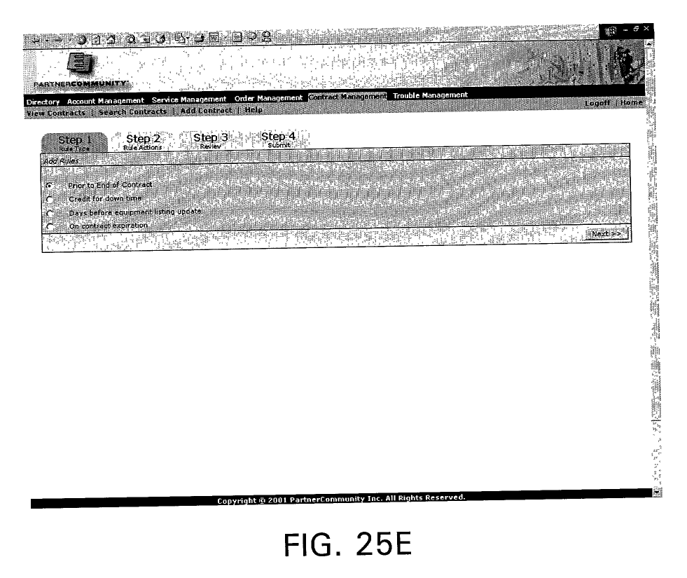

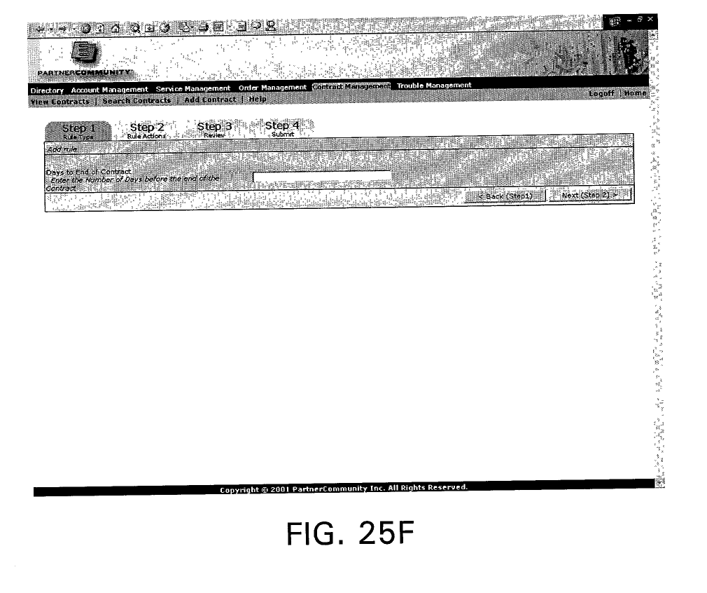

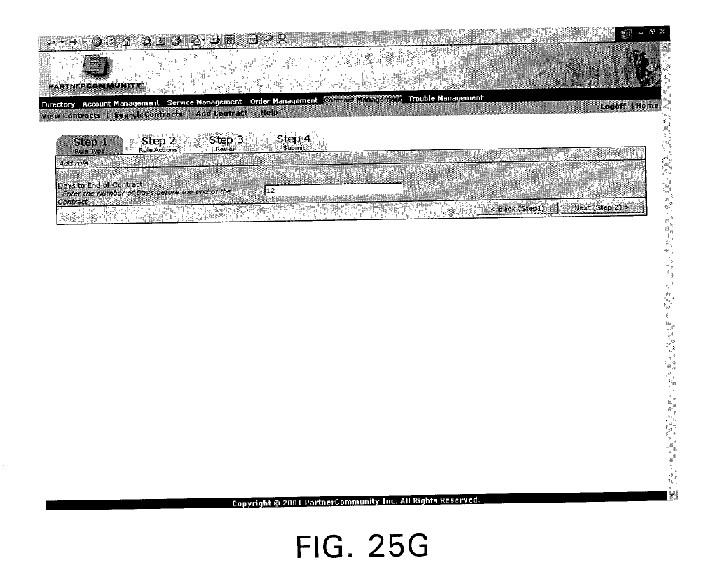

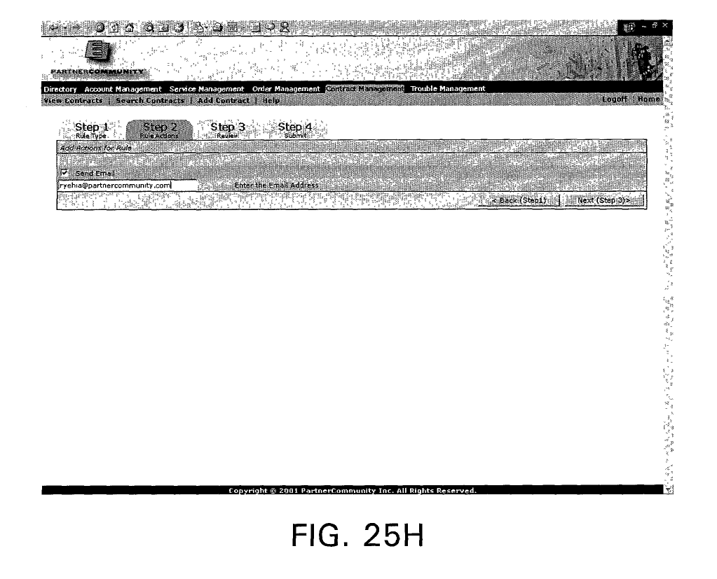

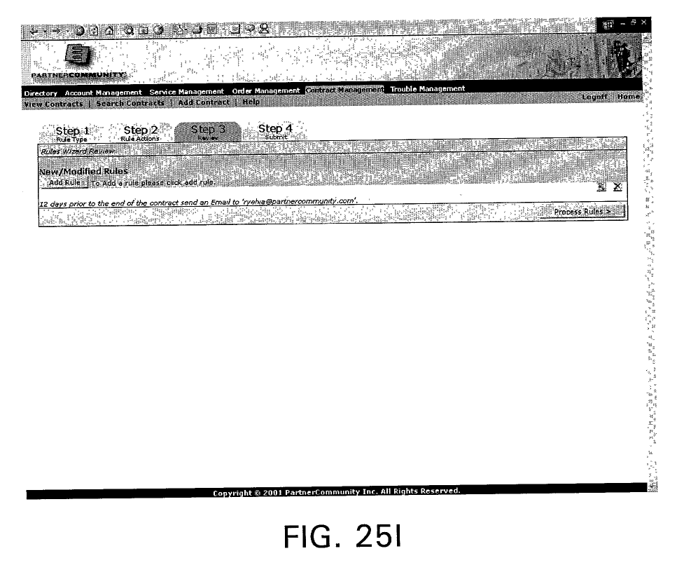

Turning to Step 3 shown in FIG. 25C; it illustrates a review of the first rule entered “after specified hours of down time, then apply number of credit hours”. Another rule is entered as shown in FIG. 25E-25I. In FIG. 25E “Prior to the end of contract” rule is selected. In FIG. 25F, the rules wizard prompts the user how many “Days to End of Contract”. In this example 12 days prior to the end of the contract are entered as shown in FIG. 25G. Next, in FIG. 25H an action for this rule is selected. In this example, e-mail notification is setup with a user name. As shown in FIG. 25I the user reviews the rule and enters it into the system 300. To summaries, once the rule entered the system 300 monitors the contract termination date and 12 days before the end of the contract an e-mail notification is sent to the address specified.

It should be understood, that using this system each user can customize her critical items and select one or more rules to perform predefined actions. This permits a user to create customized monitoring for a specific contract on a per user bases. The customized user's view allows business processes, internal to the user's systems, to be integrated into system 300. For example, one party to a contract may need more time to actually negotiate a new contract and would want a longer lead time before the expiration date of the current contract. Returning to the example above, a company with longer internal process needs may need 45 days notice rather than 12 days notice prior to the contract expiration. Also, not only may each party of a contract monitor terms and conditions of the same contract differently, but individuals within an organization that is a part to the contract can monitor the terms and conditions of the contract differently. Each of the parties can also monitor different critical items of a contract. Moreover, each user not only monitors their interpretation of the contract, e.g. view into the contract, but what actions are to be taken as well.

Non-Limiting Examples Shown

Although a specific embodiment of the invention has been disclosed. It will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A method for customizable monitoring of one or more contract clauses in a multilateral environment comprising:
retrieving one or more contract clauses from a contract between one or more parties;
defining one or more rules with the one or more contract clauses which have been retrieved, wherein each rule includes at least one condition and one or more actions to perform in response to the condition;
monitoring the clauses with the contract with the rules; and
executing the one or more actions based upon the one or more rules.

2. The method according to claim 1, wherein the rules comprise one or more rules selected from the group of rules with operators including but not limited to ≠, ≦, ≧, <,=, and >.

3. The method according to claim 1, wherein the step of retrieving contract clauses includes the sub-step of:
parsing the contract received into requested XML tag values representing predefined fields.

4. The method according to claim 1, wherein the step of predefining a rule further comprising the step of:
sending a user interface for presentation of a rules wizard including user selectable predefined fields on a first system used by a first partner.

5. The method according to claim 4, further comprising:
prompting at least one of the first partner using the first system for a set of rules to monitor contracts for a specific service identifier.

6. A method for managing multiple interpretations from a single contract in a client-server environment, the method on a server comprising the steps of:
receiving from at least one client information processing system metadata to a contract which has been previously executed by two or more parties, wherein the metadata represents critical items as defined by the at least one client information processing system;
receiving from the at least one client information processing system one or more rules based on the metadata that represents critical items; and
executing at least one of the one or more rules based on the metadata.

7. The method according to claim 6, further comprising the step of:
sending a notification to at least one client information processing system after executing at least one of the one or more rules.

8. The method according to claim 7, wherein in the step of sending a notification includes sending an e-mail notification to at least one client information processing system after executing at least one of the one or more rules.

9. The method according to claim 6, wherein the step of receiving from at least one client information processing system metadata wherein the metadata is selected from a group of contract metadata consisting of terms, conditions, dates, and payments.

10. The method according to claim 6, further comprising the step of:
receiving a user login that permits access only to predetermined areas of the contract upon which only metadata in the predetermined areas of the contract is subsequently received.

11. The method according to claim 10, further comprising the step of:
receiving a user login that permits access only to predetermined areas of the contract upon which rules in the predetermined areas of the contract can be subsequently executed.

12. The method according to claim 6, wherein the step of receiving from at least one client information processing system metadata wherein the metadata is parsed from the contract previously executed by two or more parties and the metadata is delineated by XML tags in the contract itself.

13. The method according to claim 6, wherein the step of receiving from the at least one client information system one or more rules wherein the rules are selected from a menu driven template that is presented on the at least one client information system.

14. A business method for customizable monitoring of one or more contract clauses in a multilateral environment comprising:
retrieving one or more contract clauses from a contract between one or more parties;
defining one or more rules with the one or more contract clauses which have been retrieved, wherein each rule includes at least one condition and one or more actions to perform in response to the condition;
monitoring the clauses with the contract with the rules; and
executing the one or more actions based upon the one or more rules.

15. The method according to claim 14, wherein the rules comprise one or more rules selected from the group of rules with operators including but not limited to ≠, ≦, ≧, <, =, and >.

16. The method according to claim 14, wherein the step of retrieving contract clauses includes the sub-step of:
parsing the contract received into requested XML tag values representing predefined fields.

17. The method according to claim 14, wherein the step of predefining a rule further comprising the step of:
sending a user interface for presentation of a rules wizard including user selectable predefined fields on a first system used by a first partner.

18. The method according to claim 17, further comprising:
prompting at least one of the first partner using the first system for a set of rules to monitor contracts for a specific service identifier.

19. A computer readable medium containing programming instructions for managing multiple interpretations from a single contract in a client-server environment, the programming instructions on a server information processing system comprising the programming instructions comprising:
receiving from at least one client information processing system metadata to a contract which has been previously executed by two or more parties, wherein the metadata represents critical items as defined by the at least one client information processing system;
receiving from the at least one client information processing system one or more rules based on the metadata that represents critical items; and
executing at least one of the one or more rules based on the metadata.

20. The computer readable medium according to claim 19, further comprising the programming instruction of:
sending a notification to at least one client information processing system after executing at least one of the one or more rules.

21. The computer readable medium according to claim 20, wherein in the programming instruction of sending a notification includes sending an e-mail notification to at least one client information processing system after executing at least one of the one or more rules.

22. The computer readable medium according to claim 19, wherein the programming instruction of receiving from at least one client information processing system metadata wherein the metadata is selected from a group of contract metadata consisting of terms, conditions, dates, and payments.

23. The computer readable medium according to claim 19, further comprising the programming instruction of:
receiving a user login that permits access only to predetermined areas of the contract upon which only metadata in the predetermined areas of the contract is subsequently received.

24. The computer readable medium according to claim 23, further comprising the programming instruction of:
receiving a user login that permits access only to predetermined areas of the contract upon which rules in the predetermined areas of the contract can be subsequently executed.

25. The computer readable medium according to claim 19, wherein the programming instruction of receiving from at least one client information processing system metadata wherein the metadata is parsed from the contract previously executed by two or more parties and the metadata is delineated by XML tags in the contract itself.

26. The computer readable medium according to claim 19, wherein the programming instruction of receiving from the at least one client information system one or more rules wherein the rules are selected from a menu driven template that is presented on the at least one client information system.

27. A method for managing multiple interpretations from a single contract in a client-server environment, the method on a client information processing system comprising the steps of:
presenting on a graphical user interface, metadata to a contract which has been previously executed by two or more parties, wherein the metadata represents critical items as defined by the at least one client information processing system;
selecting metadata based on a users preference;
sending the metadata to a centralized processing hub;
prompting on the graphical user interface, one or more rules based on the metadata that represents critical items;
sending the one or more rules entered to the centralized processing hub; and
receiving a notification when at least one of the rules sent to the processing hub has been executed for the contract.

28. A centralized processing hub for managing contracts in a multilateral environment, comprising:
a channel coupled to a network for providing protocol translation and bi-directional communication between a plurality of partner systems, wherein at least one contract has been previously executed by two or more trading partners via the partner systems; a parser coupled to the channel, which parses the previously executed contract received into one or more XML tag values representing critical items;
means for generating a graphical user interface on the at least one of the plurality of partner systems to receive a trading partner's selection of metadata to the contract and at least one customizable rule based on the metadata; a data and rules analysis engine which executes the rules received from the trading partner's selection; and
an action processor, which sends a least one notification to the partner system being used by the trading partner whose customizable rule definitions are being managed.
